(19) United States
(12) Patent Application Publication
(10) Pub. No.: US 2025/0048194 A1
(43) Pub. Date: Feb. 6, 2025

(54) INDICATING MACHINE LEARNING FUNCTIONALITY AND MODEL APPLICABILITY FOR MOBILITY SCENARIOS

(71) Applicant: QUALCOMM Incorporated, San Diego, CA (US)

(72) Inventors: Rajeev KUMAR, San Diego, CA (US); Aziz GHOLMIEH, Del Mar, CA (US); Shankar KRISHNAN, San Diego, CA (US)

(21) Appl. No.: 18/364,382

(22) Filed: Aug. 2, 2023

(51) Int. Cl. H04W 36/00; H04L 41/16

(52) U.S. Cl. CPC H04W 36/0058; H04L 41/16

(57) ABSTRACT

Methods, systems, and devices for wireless communication are described. A network entity may configure a user equipment (UE) to report applicability information associated with artificial intelligence (AI) and/or machine learning (ML) functionalities and/or models. The applicability information indicates an applicability of a functionality and/or model per AI/ML-enabled feature or feature group. Based on the applicability information and a handover of the UE from a source network entity to a target network entity, the target network entity may configure a functionality and/or model. Additionally, or alternatively, the UE may be configured with a reference configuration and one or more additional configurations corresponding to respective AI/ML functionalities and/or models. The UE may apply an additional configuration based on a handover to the target network entity, the additional configuration satisfying an applicability condition, or both. Based on an indication of the applied configuration, one or more functionalities or models may be activated.

### FIELD OF TECHNOLOGY

The following relates to wireless communication, including indicating machine learning (ML) functionality and model applicability for mobility scenarios.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support indicating machine learning (ML) functionality and model applicability for mobility scenarios. For example, the described techniques provide for performing functionality-based or model-based lifecycle management (LCM) operations during user equipment (UE) mobility (e.g., when a UE is subject to handover from a source network entity to a target network entity). In some examples, a source network entity may provide a configuration (e.g., a reporting configuration) to the UE for reporting functionality applicability information or model applicability information for one or more neighboring cells (e.g., information regarding an applicability of an artificial intelligence (AI) and/or ML functionality and/or model at the neighboring cells or for a given frequency). In accordance with the reporting configuration, the UE may report the applicability information to the source network entity. The source network entity may transmit a control message to the UE indicating a ML model configuration based on the applicability information and further indicating a handover of the UE from the source network entity to a target network entity. In some aspects, the ML model configuration is associated with one or more AI and/or ML functionalities or one or more AI and/or ML models. The target network entity may transmit a second control message activating an LCM operation.

Additionally, or alternatively, the UE may receive a control message indicating a reference configuration and one or more additional (i.e., delta) configurations for AI/ML-based procedures (e.g., LCM operations). The additional configurations may correspond to one or more AI/ML functionalities or AI/ML models. The UE may apply the reference configuration, the one or more additional configurations, or a combination thereof, for example, based on completing a handover from a source network entity to a target network entity, which may be based on the additional configurations satisfying an applicability criteria at the target cell. If the UE applies one or more of the additional configurations, the UE may indicate, to the source network entity or the target network entity, that the UE applied the one or more additional configurations, and the target network entity may activate the AI/ML functionalities or the AI/ML models (corresponding to the applied additional configurations) at the UE.

A method for wireless communications by a UE is described. The method may include receiving, from a source network entity, a message indicating a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, transmitting, to the source network entity, a report indicating the applicability information based on the reporting configuration, receiving, from the source network entity, a first control message indicating a ML model configuration based on the applicability information and a request to handover the UE from the source network entity to a target network entity, where the ML model configuration is associated with the one or more ML functionalities or the one or more ML models, and receiving, from the target network entity, a second control message activating the one or more ML functionalities or the one or more ML models, where the activation is based on the handover, the applicability information, and the ML model configuration.

A UE for wireless communications is described. The UE may include one or more memories storing processor executable code, and one or more processors coupled with the one or more memories. The one or more processors may individually or collectively operable to execute the code to cause the UE to receive, from a source network entity, a message indicating a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, transmit, to the source network entity, a report indicating the applicability information based on the reporting configuration, receive, from the source network entity, a first control message indicating a ML model configuration based on the applicability information and a request to handover the UE from the source network entity to a target network entity, where the ML model configuration is associated with the one or more ML functionalities or the one or more ML models, and receive, from the target network entity, a second control message activating the one or more ML functionalities or the one or more ML models, wherein the activation is based on the handover, the applicability information, and the ML model configuration.

Another UE for wireless communications is described. The UE may include means for receiving, from a source network entity, a message indicating a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, means for transmitting, to the source network entity, a report indicating the applicability information based on the reporting configuration, means for receiving, from the source network entity, a first control message indicating a ML model configuration based on the applicability information and a request to handover the UE from the source network entity to a target network entity, where the ML model configuration is associated with the one or more ML functionalities or the one or more ML models, and means for receiving, from the target network entity, a second control message activating the one or more ML functionalities or the one or more ML models, wherein the activation is based on the handover, the applicability information, and the ML model configuration.

A non-transitory computer-readable medium storing code for wireless communications is described. The code may include instructions executable by one or more processors to receive, from a source network entity, a message indicating a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, transmit, to the source network entity, a report indicating the applicability information based on the reporting configuration, receive, from the source network entity, a first control message indicating a ML model configuration based on the applicability information and a request to handover the UE from the source network entity to a target network entity, where the ML model configuration is associated with the one or more ML functionalities or the one or more ML models, and receive, from the target network entity, a second control message activating the one or more ML functionalities or the one or more ML models, wherein the activation is based on the handover, the applicability information, and the ML model configuration.

In some examples of the method, UEs, and non-transitory computer-readable medium described herein, transmitting the report may include operations, features, means, or instructions for transmitting, to the source network entity, a measurement report indicating the applicability information and one or more radio resource management (RRM) measurements.

In some examples of the method, UEs, and non-transitory computer-readable medium described herein, transmitting the report may include operations, features, means, or instructions for transmitting, to the source network entity, UE assistance information (UAI) indicating the applicability information based on a periodicity or a trigger.

In some examples of the method, UEs, and non-transitory computer-readable medium described herein, receiving the message indicating the reporting configuration may include operations, features, means, or instructions for receiving, from the source network entity, dedicated signaling or system information indicating the reporting configuration for reporting the applicability information.

In some examples of the method, UEs, and non-transitory computer-readable medium described herein, the reporting configuration indicates one or more target network entity IDs, a target coverage area, a coverage area configuration, or a combination thereof, associated with the applicability information.

In some examples of the method, UEs, and non-transitory computer-readable medium described herein, the applicability information indicates the applicability of the one or more ML functionalities or the one or more ML models to a set of target network entities, one or more coverage areas, or a combination thereof.

In some examples of the method, UEs, and non-transitory computer-readable medium described herein, the applicability information indicates one or more conditions for which the one or more ML functionalities or the one or more ML models may be activated in a coverage area of the one or more coverage areas.

In some examples of the method, UEs, and non-transitory computer-readable medium described herein, the target network entity may be associated with a central unit (CU) or a distributed unit (DU).

A method for wireless communications by a source network entity is described. The method may include outputting a message that indicates a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, obtaining a report indicating the applicability information based on the reporting configuration, outputting, to a target network entity, a handover request message indicating the applicability information and a request to handover a UE from the source network entity to the target network entity, obtaining, from the target network entity, a handover response message indicating a ML model configuration based on the applicability information and the request, where the ML model configuration is associated with the one or more ML functionalities or the one or more ML models, and outputting a control message indicating the ML model configuration.

A source network entity for wireless communications is described. The source network entity may include one or more memories storing processor executable code, and one or more processors coupled with the one or more memories. The one or more processors may individually or collectively operable to execute the code to cause the source network entity to output a message that indicates a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, obtain a report indicating the applicability information based on the reporting configuration, outputting, to a target network entity, a handover request message indicate the applicability information and a request to handover a UE from the source network entity to the target network entity, obtain, from the target network entity, a handover response message indicating a ML model configuration based on the applicability information and the request, where the ML model configuration is associated with the one or more ML functionalities or the one or more ML models, and output a control message indicating the ML model configuration.

Another source network entity for wireless communications is described. The source network entity may include means for outputting a message that indicates a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, means for obtaining a report indicating the applicability information based on the reporting configuration, means for outputting, to a target network entity, a handover request message indicating the applicability information and a request to handover a UE from the source network entity to the target network entity, means for obtaining, from the target network entity, a handover response message indicating a ML model configuration based on the applicability information and the request, where the ML model configuration is associated with the one or more ML functionalities or the one or more ML models, and means for outputting a control message indicating the ML model configuration.

A non-transitory computer-readable medium storing code for wireless communications is described. The code may include instructions executable by one or more processors to output a message that indicates a reporting configuration for reporting applicability information for each ML-enabled feature or feature group of a set of ML-enabled feature or feature groups, where the applicability information indicates an applicability of one or more ML functionalities or one or more ML models associated with each ML-enabled feature or feature group, obtain a report indicating the applicability information based on the reporting configuration, outputting, to a target network entity, a handover request message indicate the applicability information and a request to handover a UE from the source network entity to the target network entity, obtain, from the target network entity, a handover response message indicating a ML model configuration based on the applicability information and the request, where the ML model configuration is associated with the one or more ML functionalities or the one or more ML models, and output a control message indicating the ML model configuration.

In some examples of the method, source network entities, and non-transitory computer-readable medium described herein, obtaining the report may include operations, features, means, or instructions for obtaining a measurement report indicating the applicability information and one or more RRM measurements.

In some examples of the method, source network entities, and non-transitory computer-readable medium described herein, the handover request message indicates the one or more RRM measurements.

In some examples of the method, source network entities, and non-transitory computer-readable medium described herein, obtaining the report may include operations, features, means, or instructions for obtaining UAI indicating the applicability information based on a periodicity or a trigger.

In some examples of the method, source network entities, and non-transitory computer-readable medium described herein, outputting the message indicating the reporting configuration may include operations, features, means, or instructions for outputting dedicated signaling or system information indicating the reporting configuration for reporting the applicability information.

In some examples of the method, source network entities, and non-transitory computer-readable medium described herein, the reporting configuration indicates one or more target network entity identifiers (IDs), a target coverage area, a coverage area configuration, or a combination thereof associated with the applicability information.

In some examples of the method, source network entities, and non-transitory computer-readable medium described herein, the applicability information indicates the applicability of the one or more ML functionalities or the one or more ML models to a set of target network entities, one or more coverage areas, or a combination thereof.

In some examples of the method, source network entities, and non-transitory computer-readable medium described herein, the target network entity may be associated with a CU or a DU.

A method for wireless communications by a UE is described. The method may include receiving, from a source network entity, a first control message indicating, for each target network entity of a set of target network entities, a reference configuration and one or more additional configurations, where the one or more additional configurations correspond to one or more respective ML functionalities or one or more respective ML models and applying the reference configuration or the one or more additional configurations, or any combination thereof, based on a handover of the UE from the source network entity to a target network entity.

A UE for wireless communications is described. The UE may include one or more memories storing processor executable code, and one or more processors coupled with the one or more memories. The one or more processors may individually or collectively operable to execute the code to cause the UE to receive, from a source network entity, a first control message indicating, for each target network entity of a set of target network entities, a reference configuration and one or more additional configurations, where the one or more additional configurations correspond to one or more respective ML functionalities or one or more respective ML models and apply the reference configuration or the one or more additional configurations, or any combination thereof, based on a handover of the UE from the source network entity to a target network entity.

Another UE for wireless communications is described. The UE may include means for receiving, from a source network entity, a first control message indicating, for each target network entity of a set of target network entities, a reference configuration and one or more additional configurations, where the one or more additional configurations correspond to one or more respective ML functionalities or one or more respective ML models and means for applying the reference configuration or the one or more additional configurations, or any combination thereof, based on a handover of the UE from the source network entity to a target network entity.

A non-transitory computer-readable medium storing code for wireless communications is described. The code may include instructions executable by one or more processors to receive, from a source network entity, a first control message indicating, for each target network entity of a set of target network entities, a reference configuration and one or more additional configurations, where the one or more additional configurations correspond to one or more respective ML functionalities or one or more respective ML models and apply the reference configuration or the one or more additional configurations, or any combination thereof, based on a handover of the UE from the source network entity to a target network entity.

Some examples of the method, UEs, and non-transitory computer-readable medium described herein may further include operations, features, means, or instructions for applying the reference configuration or the one or more additional configurations, or both, may be based on the one or more respective ML functionalities or the one or more respective ML models satisfying an applicability condition associated with the one or more respective ML functionalities or the one or more ML models and the applicability condition corresponds to an applicability of the reference configuration or the one or more additional configurations, or any combination thereof.

In some examples of the method, UEs, and non-transitory computer-readable medium described herein, applying the reference configuration or the one or more additional configurations, or both may include operations, features, means, or instructions for applying the one or more additional configurations based on a completion of the handover and the one or more additional configurations satisfying an applicability condition associated with the one or more respective ML functionalities or the one or more ML models and transmitting, to the source network entity, UAI indicating the applied one or more additional configurations.

Some examples of the method, UEs, and non-transitory computer-readable medium described herein may further include operations, features, means, or instructions for receiving, from the target network entity, a control message activating the LCM operation based on the handover and the applied one or more additional configurations.

In some examples of the method, UEs, and non-transitory computer-readable medium described herein, the UAI indicates an ID corresponding to each of the applied one or more additional configurations.

Some examples of the method, UEs, and non-transitory computer-readable medium described herein may further include operations, features, means, or instructions for storing the one or more additional configurations at the UE based on refraining to apply the one or more additional configurations for the LCM operation.

Some examples of the method, UEs, and non-transitory computer-readable medium described herein may further include operations, features, means, or instructions for transmitting, to the source network entity, a measurement report indicating one or more RRM measurements.

In some examples of the method, UEs, and non-transitory computer-readable medium described herein, the target network entity may be associated with a CU or a DU.

A method for wireless communications by a source network entity is described. The method may include outputting, to a target network entity of a set of target network entities, a handover request message indicating a request to handover a UE from the source network entity to the target network entity, obtaining, from the target network entity, a handover response message indicating a reference configuration and one or more additional configurations, where the one or more additional configurations correspond to one or more respective ML functionalities or one or more respective ML models, and outputting a first control message indicating, for each target network entity of the set of target network entities, the reference configuration and the one or more additional configurations.

A source network entity for wireless communications is described. The source network entity may include one or more memories storing processor executable code, and one or more processors coupled with the one or more memories. The one or more processors may individually or collectively operable to execute the code to cause the source network entity to output, to a target network entity of a set of target network entities, a handover request message indicate a request to handover a UE from the source network entity to the target network entity, obtain, from the target network entity, a handover response message indicating a reference configuration and one or more additional configurations, where the one or more additional configurations correspond to one or more respective ML functionalities or one or more respective ML models, and output a first control message indicating, for each target network entity of the set of target network entities, the reference configuration and the one or more additional configurations.

Another source network entity for wireless communications is described. The source network entity may include means for outputting, to a target network entity of a set of target network entities, a handover request message indicating a request to handover a UE from the source network entity to the target network entity, means for obtaining, from the target network entity, a handover response message indicating a reference configuration and one or more additional configurations, where the one or more additional configurations correspond to one or more respective ML functionalities or one or more respective ML models, and means for outputting a first control message indicating, for each target network entity of the set of target network entities, the reference configuration and the one or more additional configurations.

A non-transitory computer-readable medium storing code for wireless communications is described. The code may include instructions executable by one or more processors to output, to a target network entity of a set of target network entities, a handover request message indicate a request to handover a UE from the source network entity to the target network entity, obtain, from the target network entity, a handover response message indicating a reference configuration and one or more additional configurations, where the one or more additional configurations correspond to one or more respective ML functionalities or one or more respective ML models, and output a first control message indicating, for each target network entity of the set of target network entities, the reference configuration and the one or more additional configurations.

Some examples of the method, source network entities, and non-transitory computer-readable medium described herein may further include operations, features, means, or instructions for obtaining UAI indicating that the one or more additional configurations may be applied based on a completion of the handover and the one or more additional configurations satisfying an applicability condition for the LCM operation, where the applicability condition corresponds to an applicability of the reference configuration or the one or more additional configurations, or any combination thereof, to the LCM operation.

In some examples of the method, source network entities, and non-transitory computer-readable medium described herein, outputting, to the target network entity, an indication that the one or more additional configurations may be applied.

In some examples of the method, source network entities, and non-transitory computer-readable medium described herein, the UAI indicates an ID corresponding to each of the one or more additional configurations that may be applied by the UE.

In some examples of the method, source network entities, and non-transitory computer-readable medium described herein, the target network entity may be associated with a CU or a DU.

### BRIEF DESCRIPTION OF THE DRAWINGS

FIG. 1 shows an example of a wireless communications system that supports indicating machine learning (ML) functionality and model applicability for mobility scenarios in accordance with one or more aspects of the present disclosure.

FIG. 2 shows an example of a network architecture that supports indicating ML functionality and model applicability for mobility scenarios in accordance with one or more aspects of the present disclosure.

FIG. 3 shows an example of a wireless communications system that supports indicating ML functionality and model applicability for mobility scenarios in accordance with one or more aspects of the present disclosure.

FIGS. 4 and 5 show examples of process flows that support indicating ML functionality and model applicability for mobility scenarios in accordance with one or more aspects of the present disclosure.

FIGS. 6 and 7 show block diagrams of devices that support indicating ML functionality and model applicability for mobility scenarios in accordance with one or more aspects of the present disclosure.

FIG. 8 shows a block diagram of a communications manager that supports indicating ML functionality and model applicability for mobility scenarios in accordance with one or more aspects of the present disclosure.

FIG. 9 shows a diagram of a system including a device that supports indicating ML functionality and model applicability for mobility scenarios in accordance with one or more aspects of the present disclosure.

FIGS. 10 and 11 show block diagrams of devices that support indicating ML functionality and model applicability for mobility scenarios in accordance with one or more aspects of the present disclosure.

FIG. 12 shows a block diagram of a communications manager that supports indicating ML functionality and model applicability for mobility scenarios in accordance with one or more aspects of the present disclosure.

FIG. 13 shows a diagram of a system including a device that supports indicating ML functionality and model applicability for mobility scenarios in accordance with one or more aspects of the present disclosure.

FIGS. 14 through 20 show flowcharts illustrating methods that support indicating ML functionality and model applicability for mobility scenarios in accordance with one or more aspects of the present disclosure.

### DETAILED DESCRIPTION

Wireless communications systems may support functionality-based lifecycle management (LCM) operations or model-based (e.g., model identifier (ID)-based) LCM operations for machine learning (ML) and/or artificial intelligence (AI)-enabled processes and functions. LCM may refer to the use of AI and/or ML for operations that maintain one or more wireless communication links, such as channel state information (CSI) reporting (e.g., CSI prediction), beam management operations (e.g., spatial and temporal beam prediction), positioning (e.g., AI and/or ML-assisted positioning), among other examples. Functionality-based LCM operations may be associated with AI and/or ML-enabled features (e.g., ML functionalities) enabled by configurations that are supported by a user equipment (UE). Model-based LCM operations may be associated with specific configurations or conditions of an AI and/or ML model supported by the UE.

In some examples, the UE may indicate its support for a functionality-based LCM operation, a model-based LCM operation, or both. For example, the UE may transmit UE assistance information (UAI) indicating an applicability of particular ML functions or ML models. In mobility scenarios, such as when the UE is subject to a handover from a source cell to a target cell, the target cell may be unaware of the applicability of some ML function or ML models supported at the UE. As a result, the target cell may be unable to provide corresponding configurations for AI/ML-based operations (e.g., LCM) when the UE is mobile, and the UE may experience an interruption to AI and/or ML functionality-based or model-based operations, including for LCM.

The techniques described herein support indicating an applicability of AI and/or ML functionalities or AI and/or ML models in a mobility scenario (e.g., when a UE is subject to a handover between cells). The UE may perform the LCM operation to maintain a wireless communication link, among other uses. In some examples, a UE may receive a reporting configuration for reporting applicability information associated with one or more ML functionalities or models. The applicability information may indicate an applicability of AI and/or ML functionalities (e.g., model-enabled features) or an applicability of AI and/or ML models. That is, the applicability information may indicate whether the AI and/or ML functionalities (e.g., model-enabled features) or the AI and/or ML models, or some combination thereof, are supported by the UE. In some scenarios, the reporting configuration may be for reporting applicability of the supported AI/ML functionalities or models at neighboring cells. The UE may report the applicability information to a source network entity (e.g., a source cell), and the source network entity may indicate the applicability information to a target network entity (e.g., a target cell) or candidate network entities (e.g., a candidate cells) via a handover request message. In addition to the applicability information, the handover request message may include a request to handover the UE from the source network entity to the target network entity. Based on the applicability information associated with the supported AI/ML functionalities or models at the UE, the target network entity may indicate a ML model configuration to the UE together with the handover command, where the ML model configuration may be associated with the AI and/or ML functionalities or the AI and/or ML models. After the successful handover, the target network entity may activate an LCM operation for the UE based on the AI and/or ML model configuration.

Additionally, or alternatively, the UE may receive a control message indicating a reference configuration and one or more additional configurations (e.g., AI/ML model configurations) for different AI/ML-based operations. In some aspects, the one or more additional configuration may be referred to as delta configurations or some other terminology. The additional configurations may correspond to respective configurations for one or more AI and/or ML functionalities or AI and/or ML models. The UE may apply the reference configuration, the one or more additional configurations, or a combination thereof. For example, the UE may apply the one or more additional configurations based on completing a handover from a source network entity to a target network entity, based on at least one of the additional configurations satisfying an applicability criteria at the target cell. If the UE applies the additional configurations, the UE may indicate the application to the source network entity and/or the target network entity, and the target network entity may activate the AI and/or ML functionalities or the AI and/or ML models (corresponding to the applied additional configurations) for the UE.

Aspects of the disclosure are initially described in the context of wireless communications systems. Aspects of the disclosure are then described in the context of network architecture and process flows. Aspects of the disclosure are further illustrated by and described with reference to apparatus diagrams, system diagrams, and flowcharts that relate to indicating ML functionality and model applicability for mobility scenarios.

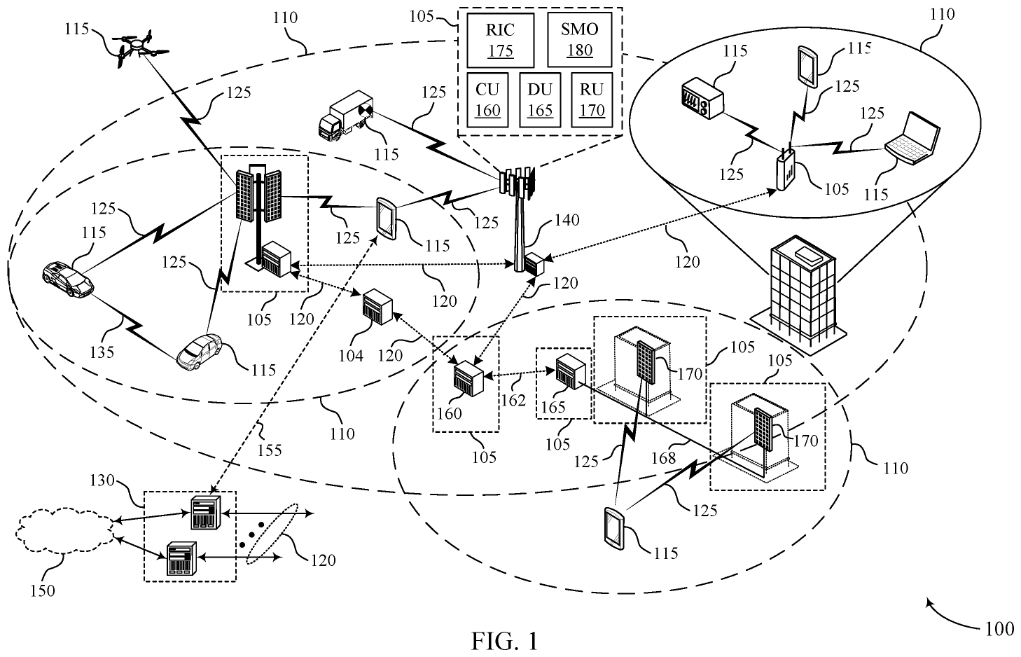

FIG. 1 shows an example of a wireless communications system 100 that supports indicating ML functionality and model applicability for mobility scenarios in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1. In some examples, a UE 115 may support AI or ML, which the UE 115 may use to perform wireless communications procedures (e.g., CSI prediction, beam selection or beam prediction, among other examples). The UE may perform LCM operations for a given AI/ML model and/or functionality (e.g., model or functionality selection, activation, deactivation, switching, and fallback, among other examples). As described herein, an AI functionality or AI model may be referred to as a ML functionality or ML model, or vice versa. That is, the terms “AI” and “ML” may, in some examples, be used interchangeably to refer to similar technologies, models, functions, or any combination thereof. In some examples, ML operations may be considered a subset of AI operations. In any case, aspects of the features described herein may be referred to as ML functionalities and ML models, but these aspects may be similarly applicable to AI functionalities and AI models, and reference to ML herein should not be considered limiting to the scope of the claims or the disclosure.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support indicating ML functionality and model applicability for mobility scenarios as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a UE 115 may be transferred from a serving network entity 105 (referred to as the source network entity, source cell, or similar terminology) to another network entity 105 (referred to as the target network entity, target cell, or similar terminology). For example, the UE 115 may be moving into the coverage area of the target network entity 105, or the target network entity 105 may be capable of providing relatively improved service for the UE 115 or capable of relieving the source network entity 105 of excess load, among other examples. The transition may be referred to as a “handover.” Prior to a handover, the source network entity 105 may configure the UE 115 with procedures for measuring the signal quality of one or more neighboring (e.g., nearby) network entities 105 (referred to as candidate network entities, candidate cells, or similar terminology). The UE 115 may then respond with a measurement report. The source network entity 105 may use the measurement report to make the handover decision. The decision may also be based on radio resource management (RRM) factors, such as network load and interference mitigation. When the handover decision is made, the source network entity 105 may send a handover request message to the target network entity 105, which may include context information to prepare the target network entity 105 to serve the UE 115. The target network entity 105 may make an admission control decision, for example, to ensure that it can meet the QoS standards of the UE 115. The target network entity 105 may then configure resources for the incoming UE 115 and send a handover request acknowledge message to the source network entity 105, which may include RRC information to be passed on to the UE 115. The source network entity 105 may then direct the UE 115 to perform the handover and pass a status transfer message to the target network entity 105 (e.g., with packet data convergence protocol (PDCP) bearer status information). In some examples, the UE 115 may attach to the target network entity 105 via a random access (RACH) procedure.

The wireless communications system 100 may support functionality-based LCM and model-based LCM. Functionality-based LCM may be associated with AI and/or ML-enabled features or feature groups enabled by configurations. A UE 115 may support the configurations based on conditions indicated by a UE capability. In some examples, additional conditions (e.g., scenarios, sites, datasets) may be considered to aid transparent model operations at the UE 115 (without model identification) at the functionality level. Model-based LCM may be associated with specific configurations or conditions supported by a UE (e.g., as indicated in a UE capability) for an AI and/or ML-enabled feature or feature group. In addition, the model-based LCM may be associated with additional conditions (e.g., scenarios, sites, datasets) as determined or identified between the UE 115 and the network entity 105. In some examples, different aspects may be considered as additional conditions and may be included into model description information during model identification.

In some examples, the UE 115 may transmit UAI to indicate an applicability of (e.g., an indication of support for) particular features to the UE 115 such that the network entity 105 may configure a functionality or model-based LCM operation. For example, the UE 115 may receive, from a network entity 105, an inquiry for a UE capability. The UE 115 may transmit a UE capability response indicating one or more AI-related features that the UE 115 supports. In response, the UE 115 may receive an RRCConnectionReconfiguration message indicating the one or more AI-related features and including assisted information if used in data collection of the one or more AI-related features. In some cases, the UE 115 may determine whether a ML model supported at the UE is trained for this particular case, and the UE 115 may transmit an RRCReconfigurationComplete message indicating the support or lack of support for the ML model. That is, for functionality-based LCM, the network entity 105 may define one or more features or feature groups per AI or ML function (and once the function is activated, the UE 115 may determine which ML models to use). For model-based LCM, the network entity 105 may indicate which AI and/or ML models the UE 115 may use or may refrain from using.

In some examples, the UE 115 may use a particular signaling framework (e.g., a NeedforGaps framework) to dynamically indicate its capability. For example, for scenario and site-specific ML models, the UE 115 may report whether it supports a scenario or site-specific model in the RRCReconfigurationComplete message. For configuration or dataset-specific models, the UE 115 may determine whether there is a corresponding ML model trained for this configuration or dataset. If the UE 115 lacks support for the scenario, site, configuration, or dataset-specific models, the network entity 105 may refrain from further configuring a ML functionality or model for the UE 115.

Some wireless communications systems, however, may lack support for AI or ML-based procedures (e.g., functionality or model-based LCM) during mobility, for example, when the UE 115 subject to handover from a source network entity 105 (e.g., a source cell) to a target network entity 105 (e.g., a target cell). For example, the target network entity 105 may lack techniques to provide a configuration (e.g., the RRCConnectionReconfiguration) based on the applicability of a functionality or a model while the UE 115 is moving. That is, during mobility scenarios, the UE 115 may be unable to use the NeedforGap framework for indicating functionality and/or model applicability. Thus, if the target network entity 105 is unaware of the functionality or model applicability, the target network entity 105 may be unable to provide an AI and/or ML configuration to the UE 115 during or after a handover. This may result in the interruption of AI and ML-based operations at the UE 115, including LCM operations.

To reduce the interruptions and improve the quality of AI and ML-based operations (e.g., functionality or model-based LCM), the wireless communications system 100 may support techniques for indicating ML functionality and model applicability in mobility scenarios. In some examples, a source network entity 105 may provide a configuration to the UE 115 for reporting functionality or model applicability information for an LCM operation. The UE 115 may report the applicability information to the source network entity 105, and the source network entity 105 may transmit a control message to the UE 115 indicating a ML model configuration based on the applicability information and a handover of the UE 115 from the source network entity 105 to a target network entity 105. The ML model configuration may be associated with one or more ML functionalities or one or more ML models. The target network entity 105 may transmit a second control message activating an LCM operation. Additionally, or alternatively, the UE 115 may receive a control message indicating a reference configuration and one or more additional (i.e., delta) configurations for an LCM operation, the additional configurations corresponding to one or more ML functionalities or ML models. The UE 115 may apply one or more of the refence configuration and the one or more additional configurations based on over from a source network entity 105 to a target network entity 105, based on the additional configurations satisfying an applicability criteria, or both. The target network entity 105 may activate the ML functionalities or the ML models (corresponding to the applied additional configurations) to the LCM operation for the UE 115.

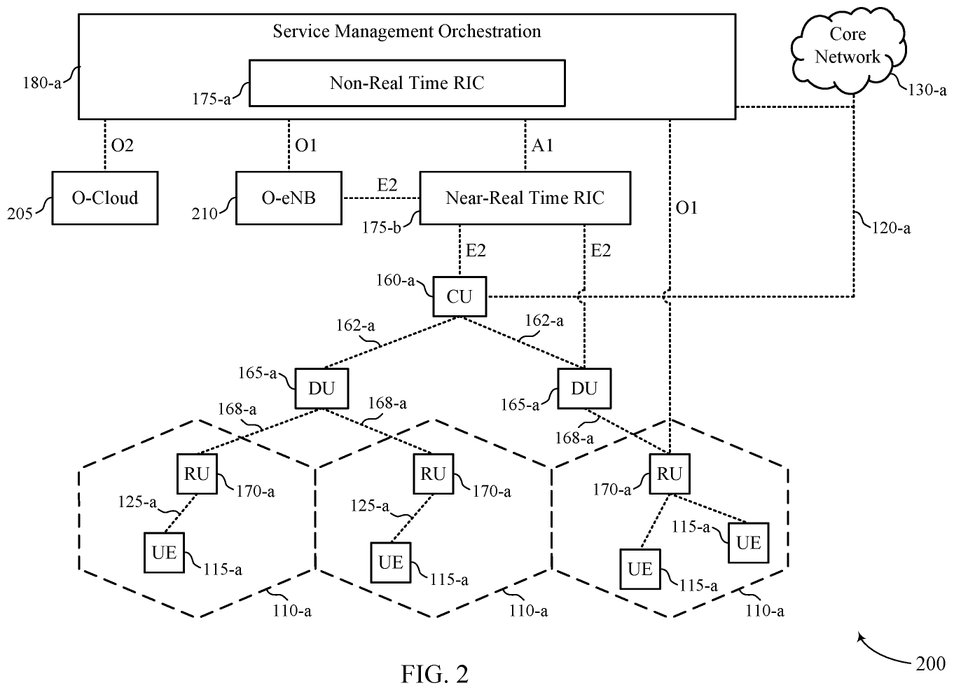

FIG. 2 shows an example of a network architecture 200 (e.g., a disaggregated base station architecture, a disaggregated RAN architecture) that supports indicating ML functionality and model applicability for mobility scenarios in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a. RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, AI or ML workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI and/or ML models to perform corrective actions through the SMO 180-a (e.g., reconfiguration via 01) or via generation of RAN management policies (e.g., A1 policies).

The network architecture 200 may support techniques for indicating ML functionality and applicability information for LCM in mobility scenarios. As described herein with reference to FIG. 1, a UE 115-a may indicate the applicability of ML functionalities and ML models to an LCM operation via an indication of applicability information in a report or based on applying a configuration associated with a particular ML functionality or model. In some examples, the UE 115-a indicates the applicability information in a report to a source network entity 105, and the source network entity 105 may indicate a model configuration to the UE 115-a, which may be associated with one or more ML functionalities or models. The source network entity 105 may be an example of a DU 165 or a CU 160. In addition, a DU 165 or a CU 160 associated with a target network entity 105 (e.g., a target cell) may activate an LCM operation for the UE 115-a based on the applicability information and a handover of the UE 115-a from the source network entity 105 to the target network entity 105. Alternatively, if the UE 115-a applies one or more configurations associated with a ML functionality or model, the UE 115-a may indicate the applied configuration(s) to a DU 165 or a CU 160 associated with a target network entity 105, and the DU 165 or the CU 160 may activate the LCM operation according to the applied configuration(s) (e.g., via signaling to the UE 115-a).

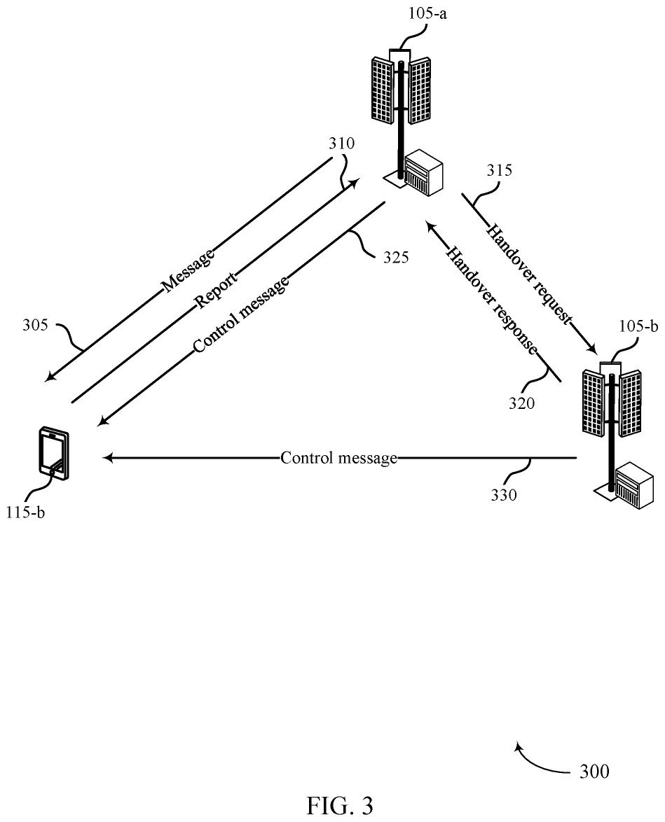

FIG. 3 shows an example of a wireless communications system 300 that supports indicating ML functionality and model applicability for mobility scenarios in accordance with one or more aspects of the present disclosure. In some examples, the wireless communications system 300 may implement aspects of the wireless communications system 100 or the network architecture 200 or may be implemented by aspects of the wireless communications system 100 or the network architecture 200. For example, the wireless communications system 300 may include a UE 115-b, a source network entity 105-a (e.g., a source cell), and a target network entity 105-b (e.g., a target cell) which may be examples of corresponding devices described herein. In some examples, the UE 115-b and the network entities 105 may support one or more ML functionalities or ML models for a functionality or model-based LCM operation in a mobility scenario.

The wireless communications system 300 may support communications between the UE 115-b and the network entities 105 via wireless communication links (e.g., uplinks and downlinks), which may be examples of communication links 125 described herein with reference to FIG. 1. In addition, the wireless communications system 300 may support mobility scenarios such as the UE 115-b switching cells or being subject to handover from the source network entity 105-a to the target network entity 105-b.

To support ML functionality or model-based LCM operations in such mobility scenarios, applicability information associated with ML functionalities and models (e.g., at the target cell) may be provided to the target network entity 105-b during handover preparation. The applicability information may indicate whether AI/ML functionalities or AI/ML models, or a combination thereof, are applicable to the UE 115-b (e.g., supported by the UE 115-b, usable by the UE 115-b). In some cases, the source network entity 105-a may provide configurations to the UE 115-b for reporting functionality and model applicability information at the neighboring cells. For example, the source network entity 105-a may transmit or output a message 305 (e.g., a control message) indicating a configuration for reporting applicability information associated with ML functionalities and models at the neighboring cells for maintaining AI/ML-based operations after the successful handover (e.g., between the UE 115-b and the target network entity 105-b). The applicability information may indicate an applicability of one or more ML functionalities (e.g., AI functionalities) or one or more ML models (e.g., AI models) supported at the neighboring cells. That is, the applicability information may indicate whether the UE 115-b may support and use the one or more ML functionalities or the one or more ML models at neighboring cells, in a RAN notification area, or in a target area.

In some examples, the source network entity 105-a, one or more target network entities 105-b, or a combination thereof may request the applicability information, which may trigger the source network entity 105-a to output the message 305. For example, if the target network entity 105-b is being selected as a next candidate cell, the target network entity 105-b may request the source network entity 105-a to obtain the applicability information such that the target network entity 105-b may configure, enable, and maintain AI/ML-based operations with the UE 115-b after the successful handover.

The source network entity 105-a may indicate the configuration (e.g., the reporting configuration) for reporting functionality and model applicability information using dedicated signaling. In such cases, the message 305 may include a UAI configuration or a measurement configuration (e.g., an RRM report for which the source network entity 105-a may reuse existing event-triggers or periodic reporting or define new event-triggers for applicability reporting). Alternatively, the source network entity 105-a may indicate the configuration (e.g., the reporting configuration) using broadcast signaling (e.g., via system information, such as a broadcast system information block (SIB) or an on-demand SIB). In some examples, existing event-triggers and/or frequency (e.g., periodicity) of reporting may be used, for example, if a size of a measurement configuration has relatively little impact on the UE 115-b. In other examples, additional (e.g., new) event triggers or reporting frequency and/or timing, or a combination thereof, may be defined for the reporting of the functionality and model applicability information.

In response to receiving the message 305, the UE 115-b may report the applicability information to the source network entity 105-a. For example, the UE 115-b may transmit a report 310 indicating the applicability information based on the configuration. In some examples, the UE 115-b may report the applicability information using UAI or using a measurement report, which may also include one or more RRM measurements. The source network entity 105-a may indicate the applicability information to the target network entity 105-b, in some cases, together with the RRM measurements. In some aspects, the source network entity 105-a may include the applicability information in a handover request message 315. For example, the source network entity 105-a may output the handover request message 315 to the target network entity 105-b, where the handover request message 315 indicates the applicability information (e.g., as provided by the UE 115-b) and a request to handover the UE 115-b from the source network entity 105-a to the target network entity 105-b. In some cases, the handover request message 315 may further include the one or more RRM measurements. That is, the handover request message 315 may trigger the UE 115-b to be handed over from the source network entity 105-a to the target network entity 105-b, for example, based on a mobility scenario of the UE 115-b in the wireless communications system 300 (e.g., the UE 115-b may be mobile and traversing respective coverage areas provided by the source network entity 105-a and the target network entity 105-b).

In some cases, the source network entity 105-a may obtain a handover response message 320 from the target network entity 105-b in response to the handover request message 315. The handover response message 320 may indicate a ML or AI model configuration, where the ML model configuration may be based on the applicability information and the request to handover the UE 115-b. In addition, the ML model configuration may be associated with the one or more ML functionalities or the one or more ML models. For example, the ML model configuration may be associated with a ML functionality if the applicability information indicated an applicability of the ML functionality. Alternatively, the ML model configuration may be associated with a particular ML model if the applicability information indicated an applicability of the ML model to the LCM operation.

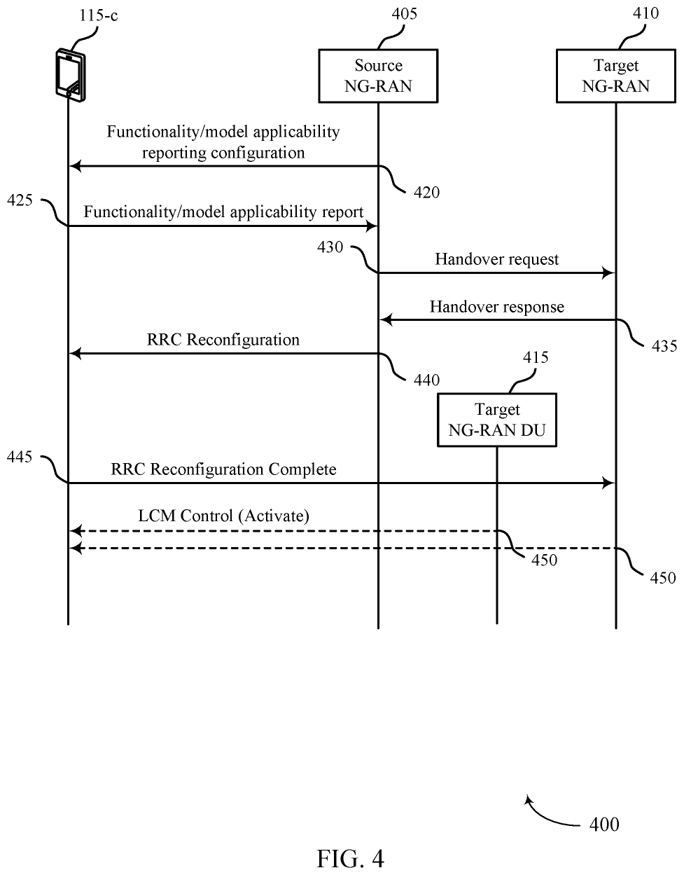

The source network entity 105-a may transmit or output a control message 325 (e.g., a first control message) to the UE 115-b indicating the ML model configuration in accordance with the indication in the handover request message 315. The UE 115-b may handover from the source network entity 105-a to the target network entity 105-b, and the target network entity 105-b may additionally provide the ML model configuration via an RRCReconfiguration message to the UE 115-b, where the ML model configuration may be based on the applicability information provided during the handover. For example, the target network entity 105-b may output a control message 330 (e.g., a second control message) that activates the LCM operation based on the handover, the applicability information, and the ML model configuration. Additional details relating to techniques for configuring the UE 115-b to report the applicability information and activating an LCM operation based on the applicability information are described herein with reference to FIG. 4.

Alternatively, the target network entity 105-b may provide a reference configuration (e.g., existing or legacy handover configuration) and one or more additional (e.g., delta) configurations for each feature or feature group associated with a ML functionality or ML model (e.g., or for each ML functionality or ML model). The reference configuration may be a baseline configuration that the UE 115-b may use while performing a handover from the source network entity 105-a to the target network entity 105-b, which may be one of a set of target network entities. An additional configuration may indicate conditions under which a feature or feature group may be applied and a corresponding ML or AI model configuration (e.g., a corresponding ML functionality or ML model). The additional configuration may also indicate updates to a lower-layer configuration that may be applicable when a given feature or feature group is applied. That is, an additional configuration may indicate one or more features and/or feature groups and a corresponding ML functionality and/or ML model the UE 115-b may use during the handover. In addition, each additional configuration may correspond to an ID.

The source network entity 105-a may exchange (e.g., output and obtain) a handover request message 315 and a handover response message 320 with the target network entity 105-b, which may communicate the reference configuration and the one or more additional configurations. The source network entity 105-a may transmit or output a control message 325 (e.g., a first control message) to the UE 115-b indicating, for each target network entity 105 of the set of target network entities, the reference configuration and the one or more additional configurations.

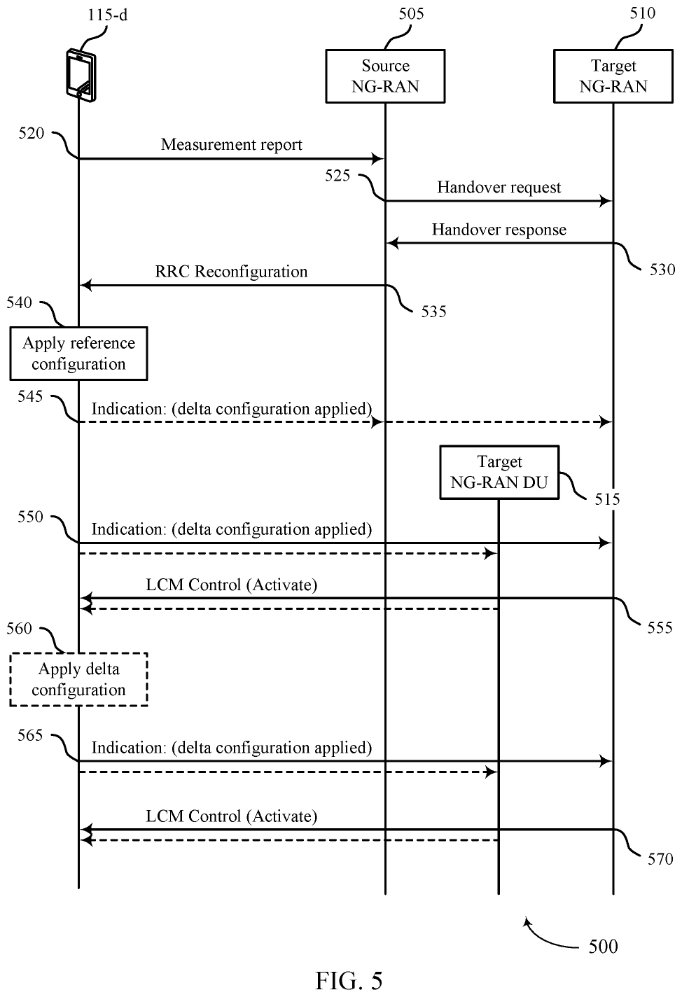

If some applicability conditions are fulfilled, the UE 115-b may be expected to apply the one or more additional configurations. For example, the UE 115-b may apply the reference configuration or the one or more additional configurations, or any combination thereof, based on handing over from the source network entity 105-a to the target network entity 105-b, based on the one or more additional configurations satisfying an applicability condition, or any combination thereof. If the UE 115-b applies the one or more additional configurations, the UE 115-b may transmit an RRCReconfiguration Complete message indicating that the one or more additional configurations have been applied (using the corresponding IDs). Additionally, the UE 115-b may use UAI to inform or update the source network entity 105-a when an additional configuration is applied (e.g., if previously configured but not applied). The target network entity 105-b may activate an LCM operation in accordance with one or more applied configurations. Additional details relating to techniques for applying the reference configuration and the one or more additional configurations for an LCM operation are described herein with reference to FIG. 5.

FIG. 4 shows an example of a process flow 400 that supports indicating ML functionality and model applicability for mobility scenarios in accordance with one or more aspects of the present disclosure. The process flow 400 may implement aspects of wireless communications systems 100 and 300 and the network architecture 200, or may be implemented by aspects of the wireless communications systems 100 and 300 and the network architecture 200. For example, the process flow 400 may illustrate operations between a UE 115-c, a source next generation RAN (NG-RAN) 405, a target NG-RAN 410, and a target NG-RAN DU 415, which may be examples of corresponding devices described herein. For example, the source NG-RAN 405, the target NG-RAN 410, and the target NG-RAN DU 415 may be examples of the network entities 105 described herein with reference to FIG. 3. In the following description of the process flow 400, the operations between the UE 115-c, the source NG-RAN 405, the target NG-RAN 410, and the target NG-RAN DU 415 may be transmitted in a different order than the example order shown, or the operations performed by the UE 115-c, the source NG-RAN 405, the target NG-RAN 410, and the target NG-RAN DU 415 may be performed in different orders or at different times. Some operations may also be omitted from the process flow 400, and other operations may be added to the process flow 400.

At 420, the source NG-RAN 405 (e.g., a source network entity 105-a) may output, and the UE 115-c may receive, a functionality/model applicability reporting configuration (e.g., via a message 305 described herein with reference to FIG. 3). That is, the source NG-RAN 405 may transmit a configuration for reporting ML functionality or model applicability information. In some examples, the source NG-RAN 405 may transmit the reporting configuration via dedicated signaling (e.g., a UAI configuration or a measurement configuration) or via system information (e.g., an on-demand SIB, a broadcast SIB). The source NG-RAN 405 or the target NG-RAN 410 may request the applicability information, for example, if the target NG-RAN 410 is a candidate cell for the UE 115-b. The reporting configuration for reporting the applicability information associated with one or more ML functionalities, models, features, or feature groups at the neighboring cells, in a RAN notification area, in a tracking area, or in a configured area may indicate one or more neighboring cell IDs (including candidate or target cells), a target coverage area, a coverage area configuration, or any combination thereof for which the applicability information is requested.

At 425, the UE 115-c may transmit, and the source NG-RAN 405 may obtain, a ML functionality or model applicability report. That is, the UE 115-c may transmit a report indicating the applicability of a ML functionality or model. The UE 115-c may report one or more features or feature groups associated with a ML functionality or model that the UE 115-c supports for one or more target or candidate cells, the target coverage area, or in a configured coverage area. In addition, the UE 115-c may include an indication of whether applicability conditions may be fulfilled (per feature or feature group) for the one or more target or candidate cells, the target coverage area, or the configured coverage area. As such, the applicability information may indicate the applicability of one or more ML or AI functionalities or one or more ML or AI models to a set of target cells (e.g., target NG-RANs 105), one or more coverage areas, or a combination thereof. In some examples, the UE 115-c may report the ML functionality or model applicability information using UAI (which may be periodic or event-triggered), a measurement report (which may be based on existing events or new events and may include one or more RRM measurements), or any other uplink report or signaling.

At 430, the source NG-RAN 405 may output, and the target NG-RAN 410 may receive, the applicability information reported by the UE 115-c. In some examples, the target NG-RAN may be an example of a target network entity 105-b, a CU associated with the target network entity 105-b, and may correspond to a target cell, a candidate cell, or a neighboring cell. In some examples, the source NG-RAN 405 may indicate the applicability information in a handover request message, an access and mobility information message, or in another inter-node message. In some examples, the handover request message may also include a request to handover the UE 115-c from the source NG-RAN 405 to the target NG-RAN 410. Additionally, or alternatively, the handover request message may indicate one or more RRM measurements provided by the UE 115-c.

At 435, the target NG-RAN 410 may output, and the source NG-RAN 405 may obtain, a handover response message indicating a ML or AI model configuration per feature, feature group, ML functionality, or ML model. That is, the target NG-RAN 410 may configure and indicate one or more ML functionalities or one or more ML models that the UE 115-c has indicated support for in the ML functionality or model applicability information.

At 440, the source NG-RAN 405 may output, and the UE 115-c may receive, an RRC Reconfiguration message (e.g., RRCReconfiguration) indicating the ML model configuration per feature, feature group, ML functionality, or ML model, and per candidate cell or per target cell. That is, the RRC Reconfiguration message may indicate a different ML functionality or ML model based on which candidate or target cell (e.g., the target NG-RAN 410) configured the ML model configuration.

At 445, the UE 115-c may transmit, and the target NG-RAN 410 may obtain, an RRC Reconfiguration Complete message (e.g., RRCReconfigurationComplete) based on receiving the RRC Reconfiguration message and based on handing over from the source NG-RAN 405 to the target NG-RAN 410. The RRC Reconfiguration Complete message may indicate that the UE 115-c is applying the indicated ML model configuration.

At 450, the UE 115-c may receive, and the target NG-RAN 410 or the target NG-RAN DU 415 may transmit, a control message (e.g., LCM control) activating an LCM operation for a given ML functionality or ML model. The target NG-RAN DU 415 may be an example of a DU associated with the target network entity 105-b. The target NG-RAN 410 or the target NG-RAN DU 415 may output this additional signaling if the LCM operation was not previously activated in the RRC Reconfiguration message output by the source NG-RAN 405. In some examples (e.g., when the UE 115-c switches to a different candidate cell than the target NG-RAN 410), the target NG-RAN 410 or the target NG-RAN DU 415 may transmit a message to deactivate the LCM operation and the UE 115-c may again perform the signaling described herein with the different candidate cell.

FIG. 5 shows an example of a process flow 500 that supports indicating ML functionality and model applicability for mobility scenarios in accordance with one or more aspects of the present disclosure. The process flow 500 may implement aspects of wireless communications systems 100 and 300 and the network architecture 200, or may be implemented by aspects of the wireless communications systems 100 and 300 and the network architecture 200. For example, the process flow 500 may illustrate operations between a UE 115-d, a source NG-RAN 505, a target NG-RAN 510, and a target NG-RAN DU 515, which may be examples of corresponding devices described herein. For example, the source NG-RAN 505, the target NG-RAN 510, and the target NG-RAN DU 515 may be examples of the network entities 105 described herein with reference to FIG. 3. In the following description of the process flow 500, the operations between the UE 115-d, the source NG-RAN 505, the target NG-RAN 510, and the target NG-RAN DU 515 may be transmitted in a different order than the example order shown, or the operations performed by the UE 115-d, the source NG-RAN 505, the target NG-RAN 510, and the target NG-RAN DU 515 may be performed in different orders or at different times. Some operations may also be omitted from the process flow 500, and other operations may be added to the process flow 500.

At 520, the UE 115-d may transmit, and the source NG-RAN 505 may obtain, a measurement report indicating one or more RRM measurements. The source NG-RAN 505 may be an example of a source network entity 105-a described herein with reference to FIG. 3.

At 525, the source NG-RAN 505 may output, and the target NG-RAN 510 may obtain, a handover request message indicating a request to handover the UE 115-d from the source NG-RAN 505 to the target NG-RAN 510. The target NG-RAN 510 may be an example of a target network entity 105-b, a CU associated with the target network entity 105-b, and may correspond to a target cell, a candidate cell, or a neighboring cell.

At 530, the source NG-RAN 505 may obtain, and the target NG-RAN 510 may output, a handover response message indicating a reference configuration and one or more additional (i.e., delta) configurations (e.g., AI/ML model configurations) for the UE 115-d (e.g., an LCM operation for maintaining a wireless communication link). The one or more additional configurations may correspond to one or more respective ML functionalities or one or more respective ML models. That is, the target NG-RAN 510 may configure a ML functionality or model configuration for the UE 115-d based on the UE 115-d being subject to handover from the source NG-RAN 505 to the target NG-RAN 510. The target NG-RAN 510 may configure the reference configuration and the one or more additional configurations per feature or feature group corresponding to a ML functionality or a ML model. The indication may include conditional when the UE 115-d may apply an additional configuration corresponding to a feature or feature group (or for each ML functionality or ML model). In addition, the target NG-RAN 510 may indicate a ML model configuration corresponding to each additional configuration, including corresponding updates to a lower layer configuration (which may be used to apply the features or feature groups corresponding to an additional configuration).

At 535, the source NG-RAN 505 may output, and the UE 115-d may receive, an RRC Reconfiguration message (e.g., RRCReconfiguration) indicating the reference signal configuration and the one or more additional configurations per candidate cell or target cell. That is, the source NG-RAN 505 may output the RRC Reconfiguration message for each target network entity of a set of target network entities (e.g., each target NG-RAN of a set of target NG-RANs, each RRC Reconfiguration message indicating the reference configuration and the one or more additional configurations.

At 540, the UE 115-d may apply the reference configuration, the one or more additional configurations, or any combination thereof if the applicability condition for a given feature or feature group corresponding to a ML functionality or ML model is met. For example, the UE 115-d may apply the reference configuration, the one or more additional configurations, or any combination thereof based on handing over from the source NG-RAN 505 to the target NG-RAN 510. Additionally, or alternatively, the UE 115-d may apply the reference configuration, the one or more additional configurations, or any combination thereof based on the one or more respective ML functionalities or the one or more respective ML models satisfying an applicability condition. The applicability condition may correspond to an applicability of the reference configuration or the one or more additional configurations, or any combination thereof, to a machine-learning enabled feature or feature group. For example, the applicability condition may correspond to whether the UE 115-d supports a given configuration for an LCM operation.

At 545, the UE 115-d may transmit, and the source NG-RAN 505 may obtain, an RRC Reconfiguration Complete message (e.g., RRCReconfigurationComplete) indicating that the UE 115-d applied the one or more additional configurations during the handover. That is, the UE 115-d may apply the one or more additional configurations based on a completion of the handover and the one or more additional configurations satisfying an applicability condition, and the UE 115-d may transmit UAI indicating the applied one or more additional configurations to the source NG-RAN 505. The UAI may include an ID corresponding to each of the applied additional configurations. In some examples, the source NG-RAN 505 may forward the indication that the UE 115-d applied the one or more additional configurations to the target NG-RAN 510.

At 550, based on a completion of the handover, the UE 115-d may transmit the indication of the applied one or more additional configurations directly to the target NG-RAN 510 or the target NG-RAN DU 515. The target NG-RAN DU 515 may be an example of a DU associated with the target network entity 105-b. In some examples, the UE 115-d may transmit the indication via UAI. In some examples, the UE 115-d may store any of the additional configurations that were not applied.

At 555, the UE 115-d may receive, and the target NG-RAN 510 or the target NG-RAN DU 515 may output, a control message (e.g., LCM control) activating one or more ML functionalities or one or more ML models (e.g., for an LCM operation) based on the applied reference and/or additional configurations. For example, the target cell (e.g., the CU or the DU of the target network entity 105-b) may activate ML functionalities or ML models based on the handover and the UE 115-d applying a corresponding additional configuration.

At 560, the UE 115-d may apply the one or more additional configurations not previously applied (e.g., that were stored) based on a completion of the handover and the one or more additional configurations satisfying the applicability condition. That is, the UE 115-d may apply different additional configurations before and after the handover from the source NG-RAN 505 to the target NG-RAN 510 as such mobility may change the applicability of particular ML functionalities or ML models to an LCM operation.

At 565, the UE 115-d may transmit the indication of the applied one or more additional configurations directly to the target NG-RAN 510 or the target NG-RAN DU 515. In some examples, the UE 115-d may transmit the indication via UAI.

At 570, the UE 115-d may receive, and the target NG-RAN 510 or the target NG-RAN DU 515 may output, a control message (e.g., LCM control) activating an one or more ML functionalities or one or more ML models (e.g., for an LCM operation) based on the recently applied additional configurations. For example, the target cell (e.g., the CU or the DU of the target network entity 105-b) may activate ML functionalities or ML models based on the handover and the UE 115-d applying a corresponding additional configuration (that may have been previously stored).

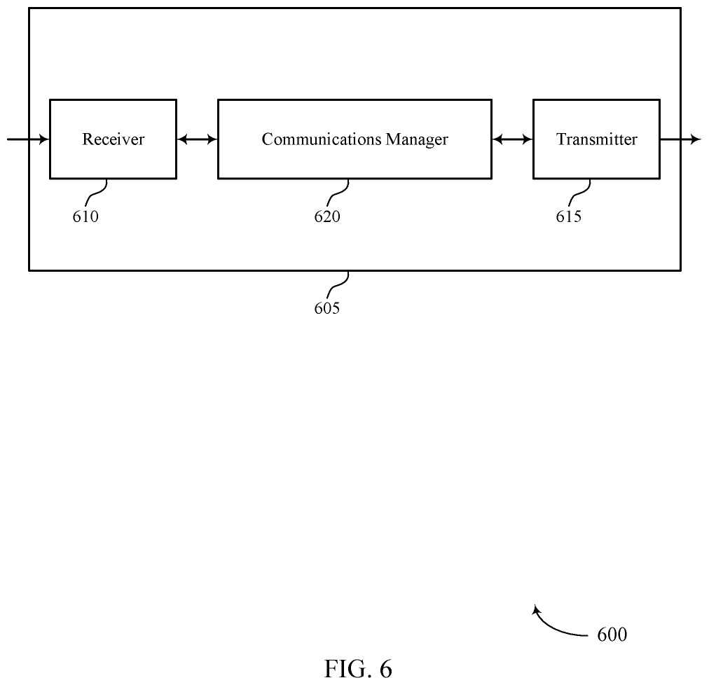

FIG. 6 shows a block diagram 600 of a device 605 that supports indicating ML functionality and model applicability for mobility scenarios in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to indicating ML functionality and model applicability for mobility scenarios). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to indicating ML functionality and model applicability for mobility scenarios). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of indicating ML functionality and model applicability for mobility scenarios as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, from a source network entity, a message indicating a reporting configuration for reporting applicability information for each ML-enabled feature or feature group of a set of ML-enabled features or feature groups. The communications manager 620 is capable of, configured to, or operable to support a means for transmitting, to the source network entity, a report indicating the applicability information based on the reporting configuration. The communications manager 620 is capable of, configured to, or operable to support a means for receiving, from the source network entity, a first control message indicating a ML model configuration based on the applicability information and a request to handover the UE from the source network entity to a target network entity, where the ML model configuration is associated with the one or more ML functionalities or the one or more ML models. The communications manager 620 is capable of, configured to, or operable to support a means for receiving, from the target network entity, a second control message activating the one or more ML functionalities or the one or more ML models, wherein the activation is based on the handover, the applicability information, and the ML model configuration.

Additionally, or alternatively, the communications manager 620 may support wireless communications in accordance with examples as disclosed herein. For example, the communications manager 620 is capable of, configured to, or operable to support a means for receiving, from a source network entity, a first control message indicating, for each target network entity of a set of target network entities, a reference configuration and one or more additional configurations, where the one or more additional configurations correspond to one or more respective ML functionalities or one or more respective ML models. The communications manager 620 is capable of, configured to, or operable to support a means for applying the reference configuration or the one or more additional configurations, or any combination thereof, based on a handover of the UE from the source network entity to a target network entity.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for indicating ML functionality and model applicability information for mobility scenarios, which may reduce processing, improve coordination between wireless devices, improve communication quality between wireless devices, and reduce latency.

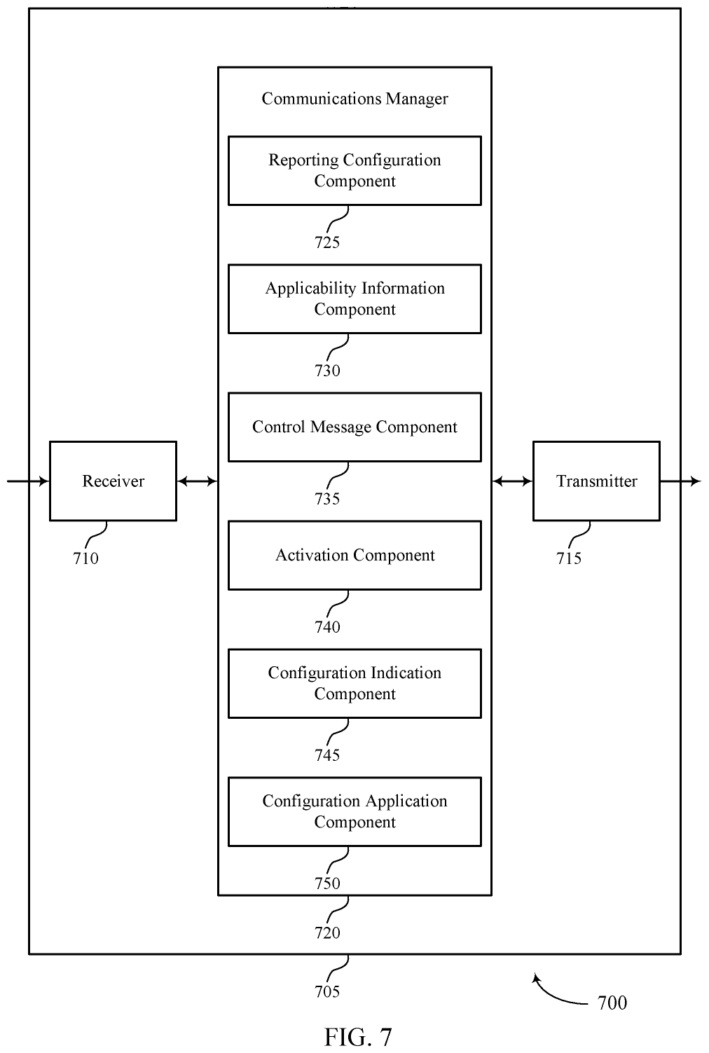

FIG. 7 shows a block diagram 700 of a device 705 that supports indicating ML functionality and model applicability for mobility scenarios in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to indicating ML functionality and model applicability for mobility scenarios). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to indicating ML functionality and model applicability for mobility scenarios). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of indicating ML functionality and model applicability for mobility scenarios as described herein. For example, the communications manager 720 may include a reporting configuration component 725, an applicability information component 730, a control message component 735, an activation component 740, a configuration indication component 745, a configuration application component 750, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The reporting configuration component 725 is capable of, configured to, or operable to support a means for receiving, from a source network entity, a message indicating a reporting configuration for reporting applicability information for each ML-enabled feature or feature group of a set of ML-enabled features or feature groups. The applicability information component 730 is capable of, configured to, or operable to support a means for transmitting, to the source network entity, a report indicating the applicability information based on the reporting configuration. The control message component 735 is capable of, configured to, or operable to support a means for receiving, from the source network entity, a first control message indicating a ML model configuration based on the applicability information and a request to handover the UE from the source network entity to a target network entity, where the ML model configuration is associated with the one or more ML functionalities or the one or more ML models. The activation component 740 is capable of, configured to, or operable to support a means for receiving, from the target network entity, a second control message activating the one or more ML functionalities or the one or more ML models, wherein the activation is based on the handover, the applicability information, and the ML model configuration.

Additionally, or alternatively, the communications manager 720 may support wireless communications in accordance with examples as disclosed herein. The configuration indication component 745 is capable of, configured to, or operable to support a means for receiving, from a source network entity, a first control message indicating, for each target network entity of a set of target network entities, a reference configuration and one or more additional configurations, where the one or more additional configurations correspond to one or more respective ML functionalities or one or more respective ML models. The configuration application component 750 is capable of, configured to, or operable to support a means for applying the reference configuration or the one or more additional configurations, or any combination thereof, based on a handover of the UE from the source network entity to a target network entity.

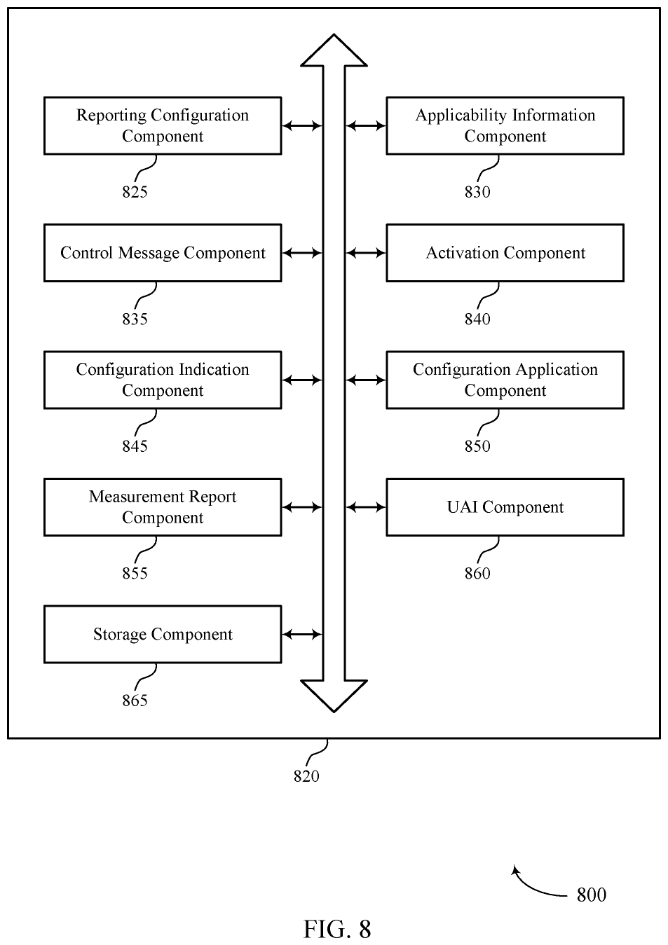

FIG. 8 shows a block diagram 800 of a communications manager 820 that supports indicating ML functionality and model applicability for mobility scenarios in accordance with one or more aspects of the present disclosure. The communications manager 820 may be an example of aspects of a communications manager 620, a communications manager 720, or both, as described herein. The communications manager 820, or various components thereof, may be an example of means for performing various aspects of indicating ML functionality and model applicability for mobility scenarios as described herein. For example, the communications manager 820 may include a reporting configuration component 825, an applicability information component 830, a control message component 835, an activation component 840, a configuration indication component 845, a configuration application component 850, a measurement report component 855, a UAI component 860, a storage component 865, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The reporting configuration component 825 is capable of, configured to, or operable to support a means for receiving, from a source network entity, a message indicating a reporting configuration for reporting applicability information for each ML-enabled feature or feature group of a set of ML-enabled features or feature groups. The applicability information component 830 is capable of, configured to, or operable to support a means for transmitting, to the source network entity, a report indicating the applicability information based on the reporting configuration. The control message component 835 is capable of, configured to, or operable to support a means for receiving, from the source network entity, a first control message indicating a ML model configuration based on the applicability information and a request to handover the UE from the source network entity to a target network entity, where the ML model configuration is associated with the one or more ML functionalities or the one or more ML models. The activation component 840 is capable of, configured to, or operable to support a means for receiving, from the target network entity, a second control message activating the one or more ML functionalities or the one or more ML models, wherein the activation is based on the handover, the applicability information, and the ML model configuration.

In some examples, to support transmitting the report, the measurement report component 855 is capable of, configured to, or operable to support a means for transmitting, to the source network entity, a measurement report indicating the applicability information and one or more RRM measurements.

In some examples, to support transmitting the report, the applicability information component 830 is capable of, configured to, or operable to support a means for transmitting, to the source network entity, UAI indicating the applicability information based on a periodicity or a trigger.

In some examples, to support receiving the message indicating the reporting configuration, the applicability information component 830 is capable of, configured to, or operable to support a means for receiving, from the source network entity, dedicated signaling or system information indicating the reporting configuration for reporting the applicability information.

In some examples, the reporting configuration indicates one or more target network entity identifiers, a target coverage area, a coverage area configuration, or a combination thereof, associated with the applicability information.

In some examples, the applicability information indicates the applicability of the one or more ML functionalities or the one or more ML models to a set of target network entities, one or more coverage areas, or a combination thereof.

In some examples, the applicability information indicates one or more conditions for which the one or more ML functionalities or the one or more ML models are activated in a coverage area of the one or more coverage areas. In some examples, the target network entity is associated with a central unit or a distributed unit.

Additionally, or alternatively, the communications manager 820 may support wireless communications in accordance with examples as disclosed herein. The configuration indication component 845 is capable of, configured to, or operable to support a means for receiving, from a source network entity, a first control message indicating, for each target network entity of a set of target network entities, a reference configuration and one or more additional configurations, where the one or more additional configurations correspond to one or more respective ML functionalities or one or more respective ML models. The configuration application component 850 is capable of, configured to, or operable to support a means for applying the reference configuration or the one or more additional configurations, or any combination thereof, based on a handover of the UE from the source network entity to a target network entity.

In some examples, applying the reference configuration or the one or more additional configurations, or both, is based on the one or more respective ML functionalities or the one or more respective ML models satisfying an applicability condition. In some examples, the applicability condition corresponds to an applicability of the reference configuration or the one or more additional configurations, or any combination thereof.

In some examples, to support applying the reference configuration or the one or more additional configurations, or both, the configuration application component 850 is capable of, configured to, or operable to support a means for applying the one or more additional configurations based on a completion of the handover and the one or more additional configurations satisfying an applicability condition. In some examples, to support applying the reference configuration or the one or more additional configurations, or both, the UAI component 860 is capable of, configured to, or operable to support a means for transmitting, to the source network entity, UAI indicating the applied one or more additional configurations.

In some examples, the activation component 840 is capable of, configured to, or operable to support a means for receiving, from the target network entity, a control message activating the one or more ML functionalities or the one or more ML models based on the handover and the applied one or more additional configurations. In some examples, the UAI indicates an identifier corresponding to each of the applied one or more additional configurations.

In some examples, the storage component 865 is capable of, configured to, or operable to support a means for storing the one or more additional configurations at the UE based on refraining to apply the one or more additional configurations.

In some examples, the measurement report component 855 is capable of, configured to, or operable to support a means for transmitting, to the source network entity, a measurement report indicating one or more RRM measurements. In some examples, the target network entity is associated with a central unit or a distributed unit.

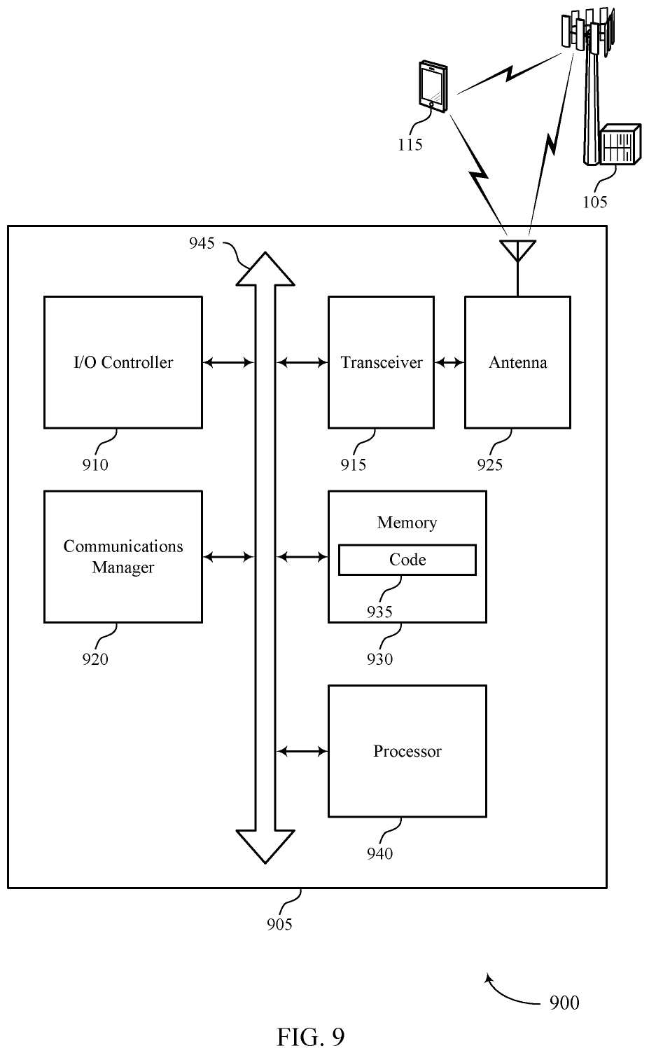

FIG. 9 shows a diagram of a system 900 including a device 905 that supports indicating ML functionality and model applicability for mobility scenarios in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting indicating ML functionality and model applicability for mobility scenarios). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein.

The communications manager 920 may support wireless communications in accordance with examples as disclosed herein. For example, the communications manager 920 is capable of, configured to, or operable to support a means for receiving, from a source network entity, a message indicating a reporting configuration for reporting applicability information for each ML-enabled feature or feature group of a set of ML-enabled features or feature groups, where the applicability information indicates an applicability of one or more ML functionalities or one or more ML models for each ML-enabled feature or feature group. The communications manager 920 is capable of, configured to, or operable to support a means for transmitting, to the source network entity, a report indicating the applicability information based on the reporting configuration. The communications manager 920 is capable of, configured to, or operable to support a means for receiving, from the source network entity, a first control message indicating a ML model configuration based on the applicability information and a request to handover the UE from the source network entity to a target network entity, where the ML model configuration is associated with the one or more ML functionalities or the one or more ML models. The communications manager 920 is capable of, configured to, or operable to support a means for receiving, from the target network entity, a second control message activating the one or more ML functionalities or the one or more ML models, wherein the activation is based on the handover, the applicability information, and the ML model configuration.

Additionally, or alternatively, the communications manager 920 may support wireless communications in accordance with examples as disclosed herein. For example, the communications manager 920 is capable of, configured to, or operable to support a means for receiving, from a source network entity, a first control message indicating, for each target network entity of a set of target network entities, a reference configuration and one or more additional configurations, where the one or more additional configurations correspond to one or more respective ML functionalities or one or more respective ML models. The communications manager 920 is capable of, configured to, or operable to support a means for applying the reference configuration or the one or more additional configurations, or any combination thereof, based on a handover of the UE from the source network entity to a target network entity.

By including or configuring the communications manager 920 in accordance with examples as described herein, the device 905 may support techniques for indicating ML functionality and model applicability information for mobility scenarios, which may reduce processing, improve coordination between wireless devices, improve communication quality between wireless devices, and reduce latency.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of indicating ML functionality and model applicability for mobility scenarios as described herein, or the at least one processor 940 and the at least one memory 930 may be otherwise configured to, individually or collectively, perform or support such operations.

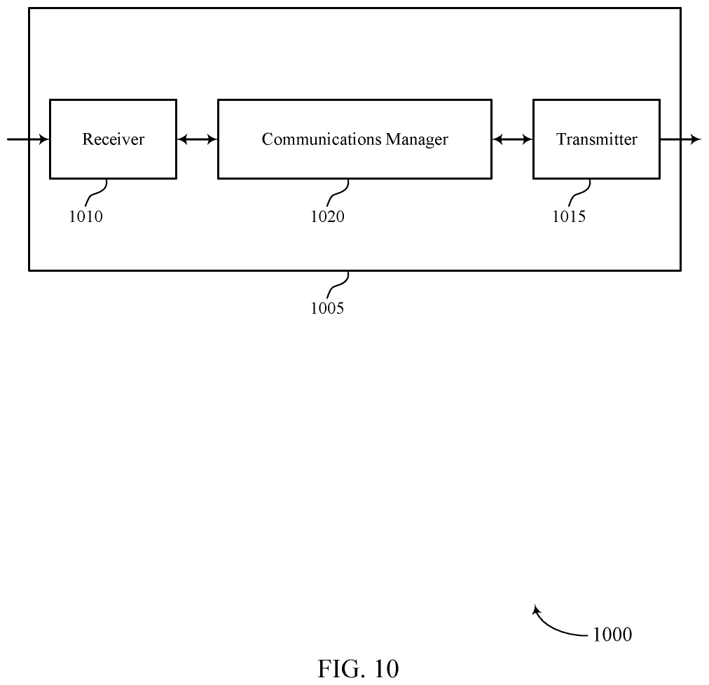

FIG. 10 shows a block diagram 1000 of a device 1005 that supports indicating ML functionality and model applicability for mobility scenarios in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of indicating ML functionality and model applicability for mobility scenarios as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a message that indicates a reporting configuration for reporting applicability information for each ML-enabled feature or feature group of a set of ML-enabled features or feature groups, where the applicability information indicates an applicability of one or more ML functionalities or one or more ML models to each ML-enabled feature or feature group. The communications manager 1020 is capable of, configured to, or operable to support a means for obtaining a report indicating the applicability information based on the reporting configuration. The communications manager 1020 is capable of, configured to, or operable to support a means for outputting, to a target network entity, a handover request message indicating the applicability information and a request to handover a UE from the source network entity to the target network entity. The communications manager 1020 is capable of, configured to, or operable to support a means for obtaining, from the target network entity, a handover response message indicating a ML model configuration based on the applicability information and the request, where the ML model configuration is associated with the one or more ML functionalities or the one or more ML models. The communications manager 1020 is capable of, configured to, or operable to support a means for outputting a control message indicating the ML model configuration.

Additionally, or alternatively, the communications manager 1020 may support wireless communications in accordance with examples as disclosed herein. For example, the communications manager 1020 is capable of, configured to, or operable to support a means for outputting, to a target network entity of a set of target network entities, a handover request message indicating a request to handover a UE from the source network entity to the target network entity. The communications manager 1020 is capable of, configured to, or operable to support a means for obtaining, from the target network entity, a handover response message indicating a reference configuration and one or more additional configurations, where the one or more additional configurations correspond to one or more respective ML functionalities or one or more respective ML models. The communications manager 1020 is capable of, configured to, or operable to support a means for outputting a first control message indicating, for each target network entity of the set of target network entities, the reference configuration and the one or more additional configurations.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for indicating ML functionality and model applicability information for mobility scenarios, which may reduce processing, improve coordination between wireless devices, improve communication quality between wireless devices, and reduce latency.

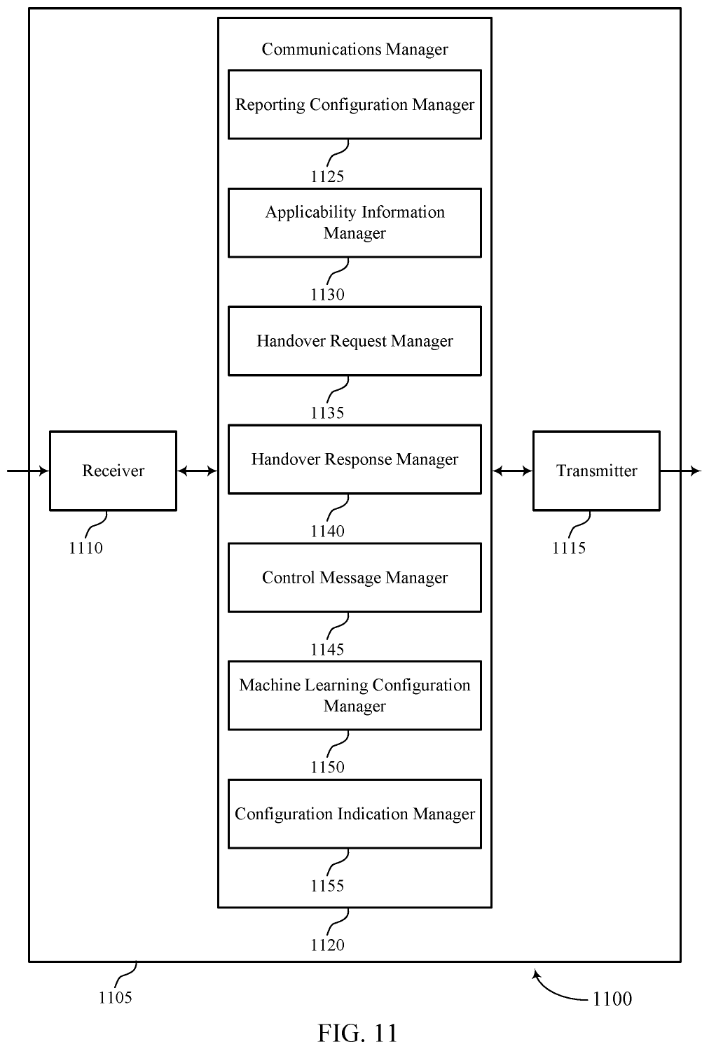

FIG. 11 shows a block diagram 1100 of a device 1105 that supports indicating ML functionality and model applicability for mobility scenarios in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of indicating ML functionality and model applicability for mobility scenarios as described herein. For example, the communications manager 1120 may include a reporting configuration manager 1125, an applicability information manager 1130, a handover request manager 1135, a handover response manager 1140, a control message manager 1145, a ML configuration manager 1150, a configuration indication manager 1155, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The reporting configuration manager 1125 is capable of, configured to, or operable to support a means for outputting a message that indicates a reporting configuration for reporting applicability information for each ML-enabled feature or feature group of a set of ML-enabled features or feature groups, where the applicability information indicates an applicability of one or more ML functionalities or one or more ML models for each ML-enabled feature or feature group. The applicability information manager 1130 is capable of, configured to, or operable to support a means for obtaining a report indicating the applicability information based on the configuration. The handover request manager 1135 is capable of, configured to, or operable to support a means for outputting, to a target network entity, a handover request message indicating the applicability information and a request to handover a UE from the source network entity to the target network entity. The handover response manager 1140 is capable of, configured to, or operable to support a means for obtaining, from the target network entity, a handover response message indicating a ML model configuration based on the applicability information and the request, where the ML model configuration is associated with the one or more ML functionalities or the one or more ML models. The control message manager 1145 is capable of, configured to, or operable to support a means for outputting a control message indicating the ML model configuration.

Additionally, or alternatively, the communications manager 1120 may support wireless communications in accordance with examples as disclosed herein. The handover request manager 1135 is capable of, configured to, or operable to support a means for outputting, to a target network entity of a set of target network entities, a handover request message indicating a request to handover a UE from the source network entity to the target network entity. The ML configuration manager 1150 is capable of, configured to, or operable to support a means for obtaining, from the target network entity, a handover response message indicating a reference configuration and one or more additional configurations, where the one or more additional configurations correspond to one or more respective ML functionalities or one or more respective ML models. The configuration indication manager 1155 is capable of, configured to, or operable to support a means for outputting a first control message indicating, for each target network entity of the set of target network entities, the reference configuration and the one or more additional configurations.

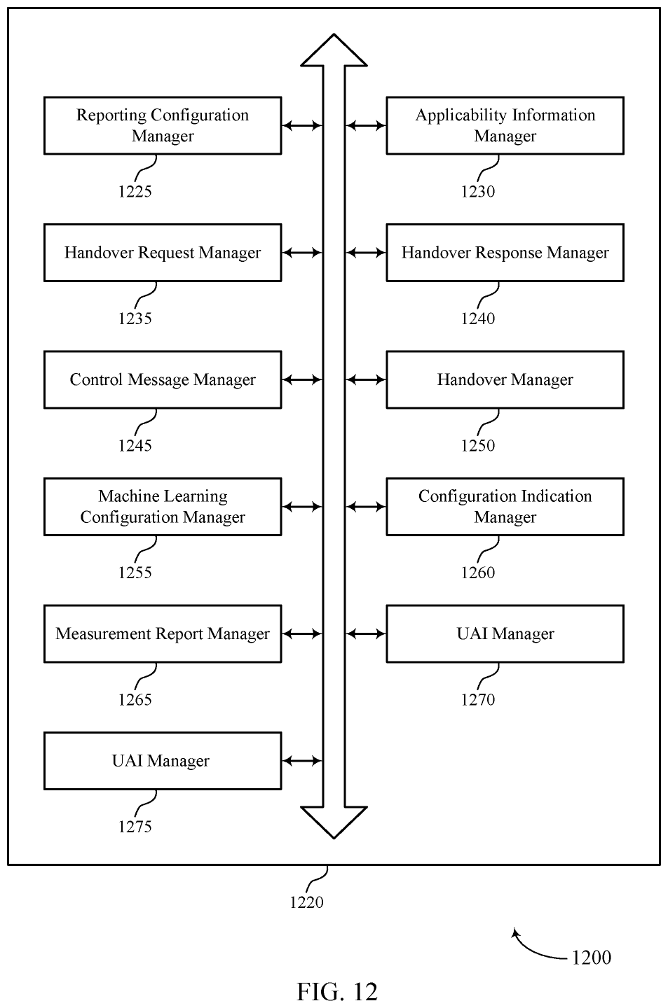

FIG. 12 shows a block diagram 1200 of a communications manager 1220 that supports indicating ML functionality and model applicability for mobility scenarios in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of indicating ML functionality and model applicability for mobility scenarios as described herein. For example, the communications manager 1220 may include a reporting configuration manager 1225, an applicability information manager 1230, a handover request manager 1235, a handover response manager 1240, a control message manager 1245, a handover manager 1250, a ML configuration manager 1255, a configuration indication manager 1260, a measurement report manager 1265, a UAI manager 1270, a UAI manager 1275, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The reporting configuration manager 1225 is capable of, configured to, or operable to support a means for outputting a message that indicates a reporting configuration for reporting applicability information for each ML-enabled feature or feature group of a set of ML-enabled features or feature groups, where the applicability information indicates an applicability of one or more ML functionalities or one or more ML models for each ML-enabled feature or feature group. The applicability information manager 1230 is capable of, configured to, or operable to support a means for obtaining a report indicating the applicability information based on the reporting configuration. The handover request manager 1235 is capable of, configured to, or operable to support a means for outputting, to a target network entity, a handover request message indicating the applicability information and a request to handover a UE from the source network entity to the target network entity. The handover response manager 1240 is capable of, configured to, or operable to support a means for obtaining, from the target network entity, a handover response message indicating a ML model configuration based on the applicability information and the request, where the ML model configuration is associated with the one or more ML functionalities or the one or more ML models. The control message manager 1245 is capable of, configured to, or operable to support a means for outputting a control message indicating the ML model configuration.

In some examples, to support obtaining the report, the measurement report manager 1265 is capable of, configured to, or operable to support a means for obtaining a measurement report indicating the applicability information and one or more RRM measurements. In some examples, the handover request message indicates the one or more RRM measurements.

In some examples, to support obtaining the report, the applicability information manager 1230 is capable of, configured to, or operable to support a means for obtaining UAI indicating the applicability information based on a periodicity or a trigger.

In some examples, to support outputting the message indicating the reporting configuration, the applicability information manager 1230 is capable of, configured to, or operable to support a means for outputting dedicated signaling or system information indicating the reporting configuration for reporting the applicability information.

In some examples, the reporting configuration indicates one or more target network entity identifiers, a target coverage area, a coverage area configuration, or a combination thereof associated with the applicability information.

In some examples, the applicability information indicates the applicability of the one or more ML functionalities or the one or more ML models to a set of target network entities, one or more coverage areas, or a combination thereof.

In some examples, the applicability information indicates one or more conditions for which the one or more ML functionalities or the one or more ML models are activated in a coverage area of the one or more coverage areas. In some examples, the target network entity is associated with a central unit or a distributed unit.

Additionally, or alternatively, the communications manager 1220 may support wireless communications in accordance with examples as disclosed herein. The handover manager 1250 is capable of, configured to, or operable to support a means for outputting, to a target network entity of a set of target network entities, a handover request message indicating a request to handover a UE from the source network entity to the target network entity. The ML configuration manager 1255 is capable of, configured to, or operable to support a means for obtaining, from the target network entity, a handover response message indicating a reference configuration and one or more additional configurations, where the one or more additional configurations correspond to one or more respective ML functionalities or one or more respective ML models. The configuration indication manager 1260 is capable of, configured to, or operable to support a means for outputting a first control message indicating, for each target network entity of the set of target network entities, the reference configuration and the one or more additional configurations.

In some examples, the UAI manager 1270 is capable of, configured to, or operable to support a means for obtaining UAI indicating that the one or more additional configurations are applied based on a completion of the handover and the one or more additional configurations satisfying an applicability condition associated with the one or more respective ML functionalities or the one or more ML models, where the applicability condition corresponds to an applicability of the reference configuration or the one or more additional configurations, or any combination thereof.

In some examples, the UAI manager 1275 is capable of, configured to, or operable to support a means for outputting, to the target network entity, an indication that the one or more additional configurations are applied.

In some examples, the UAI indicates an identifier corresponding to each of the one or more additional configurations that are applied by the UE. In some examples, the target network entity is associated with a central unit or a distributed unit.

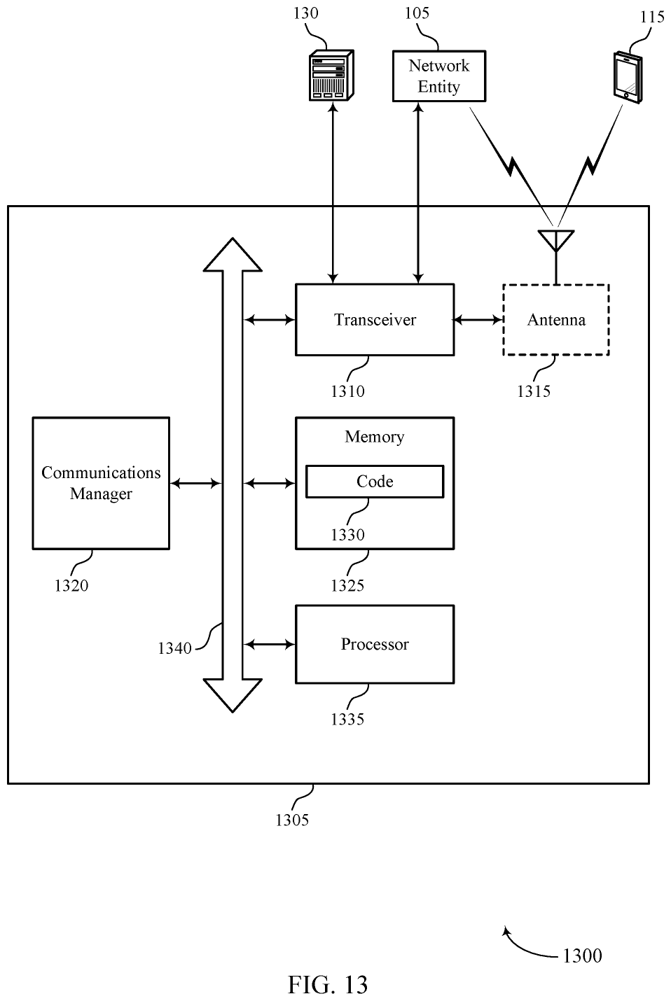

FIG. 13 shows a diagram of a system 1300 including a device 1305 that supports indicating ML functionality and model applicability for mobility scenarios in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting indicating ML functionality and model applicability for mobility scenarios). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some implementations, the at least one processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the at least one processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a message that indicates a reporting configuration for reporting applicability information for each ML-enabled feature or feature group of a set of ML-enabled features or feature groups, where the applicability information indicates an applicability of one or more ML functionalities or one or more ML models for each ML-enabled feature or feature group. The communications manager 1320 is capable of, configured to, or operable to support a means for obtaining a report indicating the applicability information based on the reporting configuration. The communications manager 1320 is capable of, configured to, or operable to support a means for outputting, to a target network entity, a handover request message indicating the applicability information and a request to handover a UE from the source network entity to the target network entity. The communications manager 1320 is capable of, configured to, or operable to support a means for obtaining, from the target network entity, a handover response message indicating a ML model configuration based on the applicability information and the request, where the ML model configuration is associated with the one or more ML functionalities or the one or more ML models. The communications manager 1320 is capable of, configured to, or operable to support a means for outputting a control message indicating the ML model configuration.

Additionally, or alternatively, the communications manager 1320 may support wireless communications in accordance with examples as disclosed herein. For example, the communications manager 1320 is capable of, configured to, or operable to support a means for outputting, to a target network entity of a set of target network entities, a handover request message indicating a request to handover a UE from the source network entity to the target network entity. The communications manager 1320 is capable of, configured to, or operable to support a means for obtaining, from the target network entity, a handover response message indicating a reference configuration and one or more additional configurations, where the one or more additional configurations correspond to one or more respective ML functionalities or one or more respective ML models. The communications manager 1320 is capable of, configured to, or operable to support a means for outputting a first control message indicating, for each target network entity of the set of target network entities, the reference configuration and the one or more additional configurations.

By including or configuring the communications manager 1320 in accordance with examples as described herein, the device 1305 may support techniques for indicating ML functionality and model applicability information for mobility scenarios, which may reduce processing, improve coordination between wireless devices, improve communication quality between wireless devices, and reduce latency.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of indicating ML functionality and model applicability for mobility scenarios as described herein, or the at least one processor 1335 and the at least one memory 1325 may be otherwise configured to, individually or collectively, perform or support such operations.

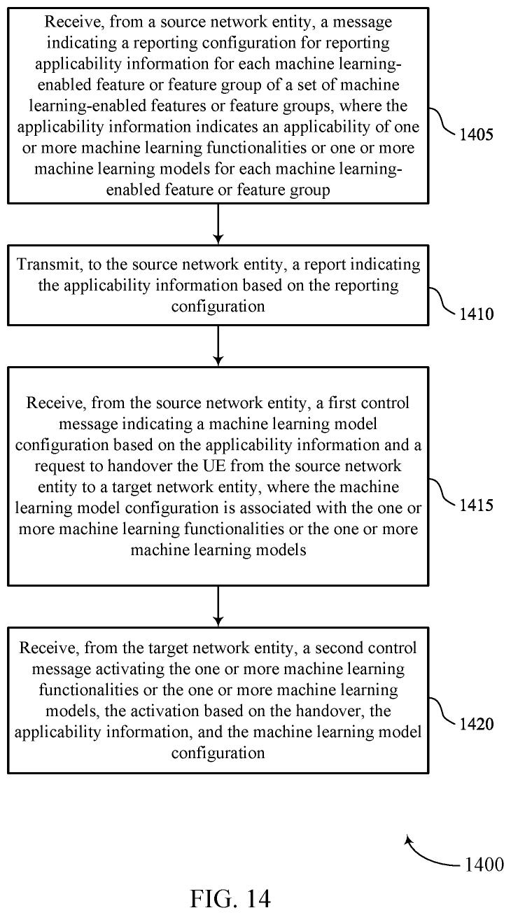

FIG. 14 shows a flowchart illustrating a method 1400 that supports indicating ML functionality and model applicability for mobility scenarios in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a source network entity, a message indicating a reporting configuration for reporting applicability information for each ML-enabled feature or feature group of a set of ML-enabled features or feature groups, where the applicability information indicates an applicability of one or more ML functionalities or one or more ML models for each ML-enabled feature or feature group. The operations of 1405 may be performed in accordance with examples as disclosed herein. In some examples, aspects of the operations of 1405 may be performed by a reporting configuration component 825 as described with reference to FIG. 8.

At 1410, the method may include transmitting, to the source network entity, a report indicating the applicability information based on the reporting configuration. The operations of 1410 may be performed in accordance with examples as disclosed herein. In some examples, aspects of the operations of 1410 may be performed by an applicability information component 830 as described with reference to FIG. 8.

At 1415, the method may include receiving, from the source network entity, a first control message indicating a ML model configuration based on the applicability information and a request to handover the UE from the source network entity to a target network entity, where the ML model configuration is associated with the one or more ML functionalities or the one or more ML models. The operations of 1415 may be performed in accordance with examples as disclosed herein. In some examples, aspects of the operations of 1415 may be performed by a control message component 835 as described with reference to FIG. 8.

At 1420, the method may include receiving, from the target network entity, a second control message activating the one or more ML functionalities or the one or more ML models, wherein the activation is based on the handover, the applicability information, and the ML model configuration. The operations of 1420 may be performed in accordance with examples as disclosed herein. In some examples, aspects of the operations of 1420 may be performed by an activation component 840 as described with reference to FIG. 8.

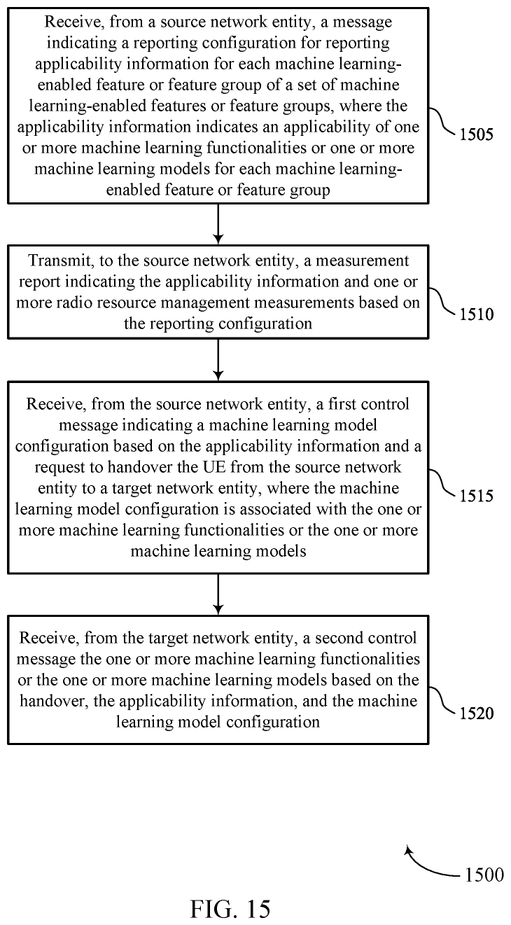

FIG. 15 shows a flowchart illustrating a method 1500 that supports indicating ML functionality and model applicability for mobility scenarios in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a source network entity, a message indicating a reporting configuration for reporting applicability information for each ML-enabled feature or feature group of a set of ML-enabled features or feature groups, where the applicability information indicates an applicability of one or more ML functionalities or one or more ML models for each ML-enabled feature or feature group. The operations of 1505 may be performed in accordance with examples as disclosed herein. In some examples, aspects of the operations of 1505 may be performed by a reporting configuration component 825 as described with reference to FIG. 8.

At 1510, the method may include transmitting, to the source network entity, a measurement report indicating the applicability information and one or more RRM measurements based on the reporting configuration. The operations of 1510 may be performed in accordance with examples as disclosed herein. In some examples, aspects of the operations of 1510 may be performed by a measurement report component 855 as described with reference to FIG. 8.

At 1515, the method may include receiving, from the source network entity, a first control message indicating a ML model configuration based on the applicability information and a request to handover the UE from the source network entity to a target network entity, where the ML model configuration is associated with the one or more ML functionalities or the one or more ML models. The operations of 1515 may be performed in accordance with examples as disclosed herein. In some examples, aspects of the operations of 1515 may be performed by a control message component 835 as described with reference to FIG. 8.

At 1520, the method may include receiving, from the target network entity, a second control message activating the one or more ML functionalities or the one or more ML models, wherein the activation is based on the handover, the applicability information, and the ML model configuration. The operations of 1520 may be performed in accordance with examples as disclosed herein. In some examples, aspects of the operations of 1520 may be performed by an activation component 840 as described with reference to FIG. 8.

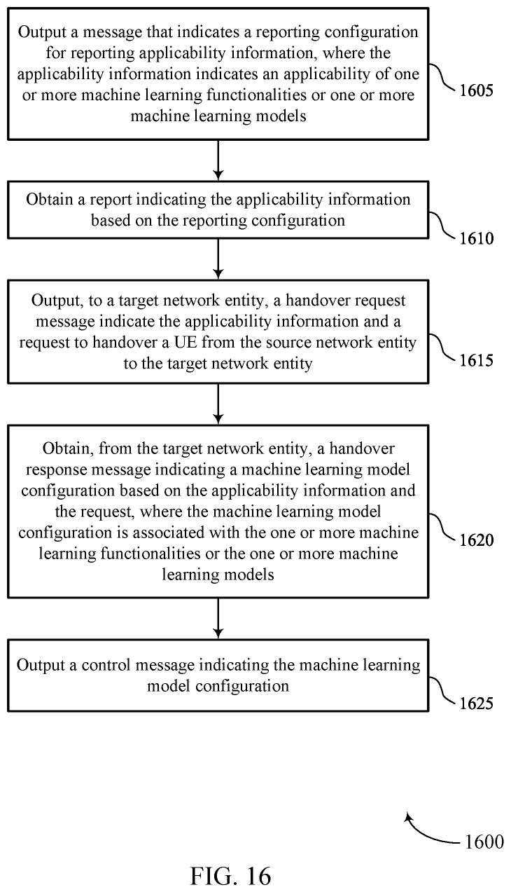

FIG. 16 shows a flowchart illustrating a method 1600 that supports indicating ML functionality and model applicability for mobility scenarios in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting a message that indicates a reporting configuration for reporting applicability information for each ML-enabled feature or feature group of a set of ML-enabled features or feature groups, where the applicability information indicates an applicability of one or more ML functionalities or one or more ML models for each ML-enabled feature or feature group. The operations of 1605 may be performed in accordance with examples as disclosed herein. In some examples, aspects of the operations of 1605 may be performed by a reporting configuration manager 1225 as described with reference to FIG. 12.

At 1610, the method may include obtaining a report indicating the applicability information based on the reporting configuration. The operations of 1610 may be performed in accordance with examples as disclosed herein. In some examples, aspects of the operations of 1610 may be performed by an applicability information manager 1230 as described with reference to FIG. 12.

At 1615, the method may include outputting, to a target network entity, a handover request message indicating the applicability information and a request to handover a UE from the source network entity to the target network entity. The operations of 1615 may be performed in accordance with examples as disclosed herein. In some examples, aspects of the operations of 1615 may be performed by a handover request manager 1235 as described with reference to FIG. 12.

At 1620, the method may include obtaining, from the target network entity, a handover response message indicating a ML model configuration based on the applicability information and the request, where the ML model configuration is associated with the one or more ML functionalities or the one or more ML models. The operations of 1620 may be performed in accordance with examples as disclosed herein. In some examples, aspects of the operations of 1620 may be performed by a handover response manager 1240 as described with reference to FIG. 12.

At 1625, the method may include outputting a control message indicating the ML model configuration. The operations of 1625 may be performed in accordance with examples as disclosed herein. In some examples, aspects of the operations of 1625 may be performed by a control message manager 1245 as described with reference to FIG. 12.

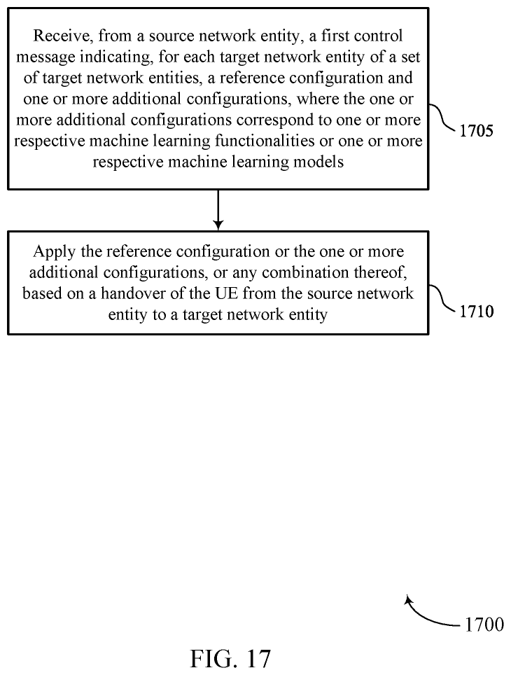

FIG. 17 shows a flowchart illustrating a method 1700 that supports indicating ML functionality and model applicability for mobility scenarios in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving, from a source network entity, a first control message indicating, for each target network entity of a set of target network entities, a reference configuration and one or more additional configurations, where the one or more additional configurations correspond to one or more respective ML functionalities or one or more respective ML models. The operations of 1705 may be performed in accordance with examples as disclosed herein. In some examples, aspects of the operations of 1705 may be performed by a configuration indication component 845 as described with reference to FIG. 8.

At 1710, the method may include applying the reference configuration or the one or more additional configurations, or any combination thereof, based on a handover of the UE from the source network entity to a target network entity. The operations of 1710 may be performed in accordance with examples as disclosed herein. In some examples, aspects of the operations of 1710 may be performed by a configuration application component 850 as described with reference to FIG. 8.

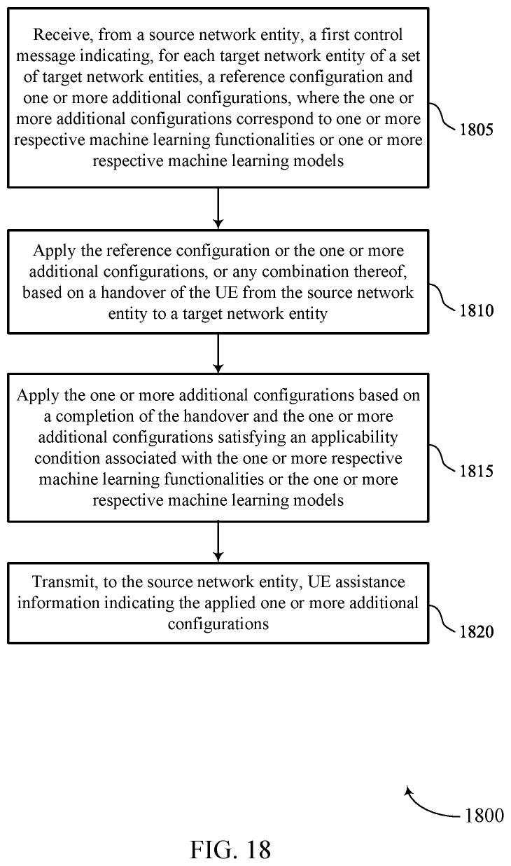

FIG. 18 shows a flowchart illustrating a method 1800 that supports indicating ML functionality and model applicability for mobility scenarios in accordance with aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include receiving, from a source network entity, a first control message indicating, for each target network entity of a set of target network entities, a reference configuration and one or more additional configurations, where the one or more additional configurations correspond to one or more respective ML functionalities or one or more respective ML models. The operations of 1805 may be performed in accordance with examples as disclosed herein. In some examples, aspects of the operations of 1805 may be performed by a configuration indication component 845 as described with reference to FIG. 8.

At 1810, the method may include applying the reference configuration or the one or more additional configurations, or any combination thereof, based on a handover of the UE from the source network entity to a target network entity. The operations of 1810 may be performed in accordance with examples as disclosed herein. In some examples, aspects of the operations of 1810 may be performed by a configuration application component 850 as described with reference to FIG. 8.

At 1815, the method may include applying the one or more additional configurations based on a completion of the handover and the one or more additional configurations satisfying an applicability condition associated with the one or more respective ML functionalities or the one or more respective ML models. The operations of 1815 may be performed in accordance with examples as disclosed herein. In some examples, aspects of the operations of 1815 may be performed by a configuration application component 850 as described with reference to FIG. 8.

At 1820, the method may include transmitting, to the source network entity, UAI indicating the applied one or more additional configurations. The operations of 1820 may be performed in accordance with examples as disclosed herein. In some examples, aspects of the operations of 1820 may be performed by a UAI component 860 as described with reference to FIG. 8.

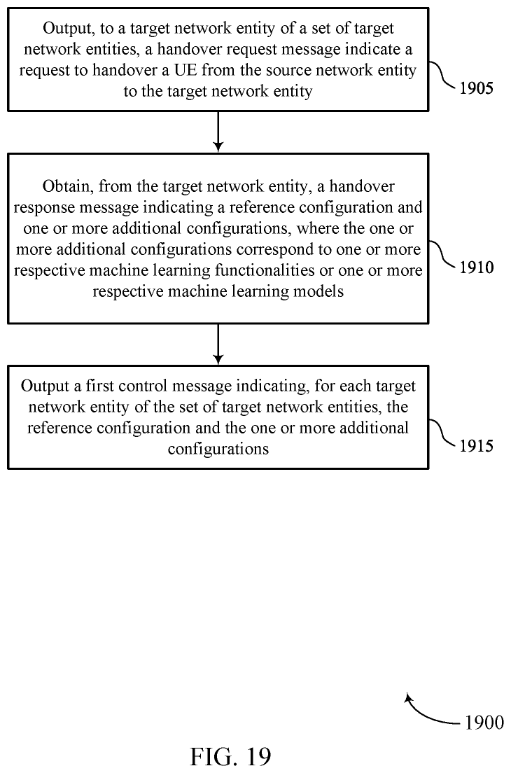

FIG. 19 shows a flowchart illustrating a method 1900 that supports indicating ML functionality and model applicability for mobility scenarios in accordance with aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include outputting, to a target network entity of a set of target network entities, a handover request message indicating a request to handover a UE from the source network entity to the target network entity. The operations of 1905 may be performed in accordance with examples as disclosed herein. In some examples, aspects of the operations of 1905 may be performed by a handover manager 1250 as described with reference to FIG. 12.

At 1910, the method may include obtaining, from the target network entity, a handover response message indicating a reference configuration and one or more additional configurations, where the one or more additional configurations correspond to one or more respective ML functionalities or one or more respective ML models. The operations of 1910 may be performed in accordance with examples as disclosed herein. In some examples, aspects of the operations of 1910 may be performed by a ML configuration manager 1255 as described with reference to FIG. 12.

At 1915, the method may include outputting a first control message indicating, for each target network entity of the set of target network entities, the reference configuration and the one or more additional configurations. The operations of 1915 may be performed in accordance with examples as disclosed herein. In some examples, aspects of the operations of 1915 may be performed by a configuration indication manager 1260 as described with reference to FIG. 12.

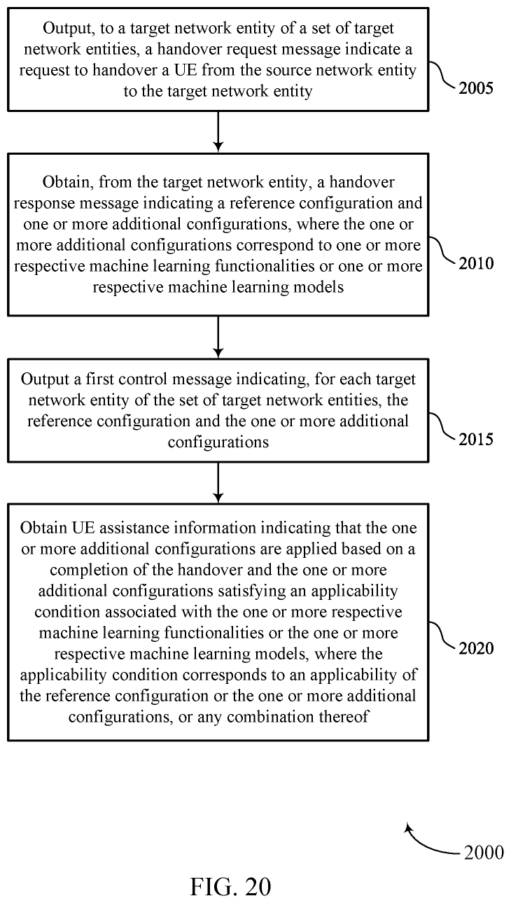

FIG. 20 shows a flowchart illustrating a method 2000 that supports indicating ML functionality and model applicability for mobility scenarios in accordance with aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include outputting, to a target network entity of a set of target network entities, a handover request message indicating a request to handover a UE from the source network entity to the target network entity. The operations of 2005 may be performed in accordance with examples as disclosed herein. In some examples, aspects of the operations of 2005 may be performed by a handover manager 1250 as described with reference to FIG. 12.

At 2010, the method may include obtaining, from the target network entity, a handover response message indicating a reference configuration and one or more additional configurations, where the one or more additional configurations correspond to one or more respective ML functionalities or one or more respective ML models. The operations of 2010 may be performed in accordance with examples as disclosed herein. In some examples, aspects of the operations of 2010 may be performed by a ML configuration manager 1255 as described with reference to FIG. 12.

At 2015, the method may include outputting a first control message indicating, for each target network entity of the set of target network entities, the reference configuration and the one or more additional configurations. The operations of 2015 may be performed in accordance with examples as disclosed herein. In some examples, aspects of the operations of 2015 may be performed by a configuration indication manager 1260 as described with reference to FIG. 12.

At 2020, the method may include obtaining UAI indicating that the one or more additional configurations are applied based on a completion of the handover and the one or more additional configurations satisfying an applicability condition associated with the one or more respective ML functionalities or the one or more respective ML models, where the applicability condition corresponds to an applicability of the reference configuration or the one or more additional configurations, or any combination thereof. The operations of 2020 may be performed in accordance with examples as disclosed herein. In some examples, aspects of the operations of 2020 may be performed by a UAI manager 1270 as described with reference to FIG. 12.

The following provides an overview of aspects of the present disclosure:

Aspect 1: A method for wireless communications at a UE, comprising: receiving, from a source network entity, a message indicating a reporting configuration for reporting applicability information for each ML-enabled feature or feature group of a set of ML-enabled feature or feature groups, wherein the applicability information indicates an applicability of one or more ML functionalities or one or more ML models associated with each ML-enabled feature or feature group; transmitting, to the source network entity, a report indicating the applicability information based at least in part on the reporting configuration; receiving, from the source network entity, a first control message indicating a ML model configuration based at least in part on the applicability information and a request to handover the UE from the source network entity to a target network entity, wherein the ML model configuration is associated with the one or more ML functionalities or the one or more ML models; and receiving, from the target network entity, a second control message activating the one or more ML functionalities or the one or more ML models, wherein the activation is based at least in part on the handover, the applicability information, and the ML model configuration.

Aspect 2: The method of aspect 1, wherein transmitting the report comprises: transmitting, to the source network entity, a measurement report indicating the applicability information and one or more RRM measurements.

Aspect 3: The method of any of aspects 1 through 2, wherein transmitting the report comprises: transmitting, to the source network entity, UAI indicating the applicability information based at least in part on a periodicity or a trigger.

Aspect 4: The method of any of aspects 1 through 3, wherein receiving the message indicating the reporting configuration comprises: receiving, from the source network entity, dedicated signaling or system information indicating the reporting configuration for reporting the applicability information.

Aspect 5: The method of any of aspects 1 through 4, wherein the reporting configuration indicates one or more target network entity IDs, a target coverage area, a coverage area configuration, or a combination thereof, associated with the applicability information.

Aspect 6: The method of any of aspects 1 through 5, wherein the applicability information indicates the applicability of the one or more ML functionalities or the one or more ML models to a set of target network entities, one or more coverage areas, or a combination thereof.

Aspect 7: The method of aspect 6, wherein the applicability information indicates one or more conditions for which the one or more ML functionalities or the one or more ML models are activated in a coverage area of the one or more coverage areas.

Aspect 8: The method of any of aspects 1 through 7, wherein the target network entity is associated with a CU or a DU.

Aspect 9: A method for wireless communications at a source network entity, comprising: outputting a message that indicates a reporting configuration for reporting applicability information for each ML-enabled feature or feature group of a set of ML-enabled feature or feature groups, wherein the applicability information indicates an applicability of one or more ML functionalities or one or more ML models associated with each ML-enabled feature or feature group; obtaining a report indicating the applicability information based at least in part on the reporting configuration; outputting, to a target network entity, a handover request message indicating the applicability information and a request to handover a UE from the source network entity to the target network entity; obtaining, from the target network entity, a handover response message indicating a ML model configuration based at least in part on the applicability information and the request, wherein the ML model configuration is associated with the one or more ML functionalities or the one or more ML models; and outputting a control message indicating the ML model configuration.

Aspect 10: The method of aspect 9, wherein obtaining the report comprises: obtaining a measurement report indicating the applicability information and one or more RRM measurements.

Aspect 11: The method of aspect 10, wherein the handover request message indicates the one or more RRM measurements.

Aspect 12: The method of any of aspects 9 through 11, wherein obtaining the report comprises: obtaining UAI indicating the applicability information based at least in part on a periodicity or a trigger.

Aspect 13: The method of any of aspects 9 through 12, wherein outputting the message indicating the reporting configuration comprises: outputting dedicated signaling or system information indicating the reporting configuration for reporting the applicability information.

Aspect 14: The method of any of aspects 9 through 13, wherein the reporting configuration indicates one or more target network entity IDs, a target coverage area, a coverage area configuration, or a combination thereof associated with the applicability information.

Aspect 15: The method of any of aspects 9 through 14, wherein the applicability information indicates the applicability of the one or more ML functionalities or the one or more ML models to a set of target network entities, one or more coverage areas, or a combination thereof.

Aspect 16: The method of any of aspects 9 through 15, wherein the target network entity is associated with a CU or a DU.

Aspect 17: A method for wireless communications at a UE, comprising: receiving, from a source network entity, a first control message indicating, for each target network entity of a set of target network entities, a reference configuration and one or more additional configurations, wherein the one or more additional configurations correspond to one or more respective ML functionalities or one or more respective ML models; and applying the reference configuration or the one or more additional configurations, or any combination thereof, based at least in part on a handover of the UE from the source network entity to a target network entity.

Aspect 18: The method of aspect 17, wherein applying the reference configuration or the one or more additional configurations, or both, is based at least in part on the one or more respective ML functionalities or the one or more respective ML models satisfying an applicability condition associated with the one or more respective ML functionalities or the one or more ML models, the applicability condition corresponds to an applicability of the reference configuration or the one or more additional configurations, or any combination thereof.

Aspect 19: The method of any of aspects 17 through 18, wherein applying the reference configuration or the one or more additional configurations, or both comprises: applying the one or more additional configurations based at least in part on a completion of the handover and the one or more additional configurations satisfying an applicability condition associated with the one or more respective ML functionalities or the one or more ML models; and transmitting, to the source network entity, UAI indicating the applied one or more additional configurations.

Aspect 20: The method of aspect 19, further comprising: receiving, from the target network entity, a control message activating the LCM operation based at least in part on the handover and the applied one or more additional configurations.

Aspect 21: The method of any of aspects 19 through 20, wherein the UAI indicates an ID corresponding to each of the applied one or more additional configurations.

Aspect 22: The method of any of aspects 17 through 21, further comprising: storing the one or more additional configurations at the UE based at least in part on refraining to apply the one or more additional configurations for the LCM operation.

Aspect 23: The method of any of aspects 17 through 22, further comprising: transmitting, to the source network entity, a measurement report indicating one or more RRM measurements.

Aspect 24: The method of any of aspects 17 through 23, wherein the target network entity is associated with a CU or a DU.

Aspect 25: A method for wireless communications at a source network entity, comprising: outputting, to a target network entity of a set of target network entities, a handover request message indicating a request to handover a UE from the source network entity to the target network entity; obtaining, from the target network entity, a handover response message indicating a reference configuration and one or more additional configurations, wherein the one or more additional configurations correspond to one or more respective ML functionalities or one or more respective ML models; and outputting a first control message indicating, for each target network entity of the set of target network entities, the reference configuration and the one or more additional configurations.

Aspect 26: The method of aspect 25, further comprising: obtaining UAI indicating that the one or more additional configurations are applied based at least in part on a completion of the handover and the one or more additional configurations satisfying an applicability condition for the LCM operation, wherein the applicability condition corresponds to an applicability of the reference configuration or the one or more additional configurations, or any combination thereof, to the LCM operation.

Aspect 27: The method of aspect 26, further comprising: outputting, to the target network entity, an indication that the one or more additional configurations are applied.

Aspect 28: The method of any of aspects 26 through 27, wherein the UAI indicates an ID corresponding to each of the one or more additional configurations that are applied by the UE.

Aspect 29: The method of any of aspects 26 through 28, wherein the target network entity is associated with a CU or a DU.

Aspect 30: A UE for wireless communications, comprising one or more memories storing processor-executable code, and one or more processors coupled with the one or more memories and individually or collectively operable to execute the code to cause the UE to perform a method of any of aspects 1 through 8.

Aspect 31: A UE for wireless communications, comprising at least one means for performing a method of any of aspects 1 through 8.

Aspect 32: A non-transitory computer-readable medium storing code for wireless communications, the code comprising instructions executable by one or more processors to perform a method of any of aspects 1 through 8.

Aspect 33: A source network entity for wireless communications, comprising one or more memories storing processor-executable code, and one or more processors coupled with the one or more memories and individually or collectively operable to execute the code to cause the source network entity to perform a method of any of aspects 9 through 16.

Aspect 34: A source network entity for wireless communications, comprising at least one means for performing a method of any of aspects 9 through 16.

Aspect 35: A non-transitory computer-readable medium storing code for wireless communications, the code comprising instructions executable by one or more processors to perform a method of any of aspects 9 through 16.

Aspect 36: A UE for wireless communications, comprising one or more memories storing processor-executable code, and one or more processors coupled with the one or more memories and individually or collectively operable to execute the code to cause the UE to perform a method of any of aspects 17 through 24.

Aspect 37: A UE for wireless communications, comprising at least one means for performing a method of any of aspects 17 through 24.

Aspect 38: A non-transitory computer-readable medium storing code for wireless communications, the code comprising instructions executable by one or more processors to perform a method of any of aspects 17 through 24.

Aspect 39: A source network entity for wireless communications, comprising one or more memories storing processor-executable code, and one or more processors coupled with the one or more memories and individually or collectively operable to execute the code to cause the source network entity to perform a method of any of aspects 25 through 29.

Aspect 40: A source network entity for wireless communications, comprising at least one means for performing a method of any of aspects 25 through 29.

Aspect 41: A non-transitory computer-readable medium storing code for wireless communications, the code comprising instructions executable by one or more processors to perform a method of any of aspects 25 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a source network entity, a message indicating a reporting configuration for reporting applicability information for each machine learning-enabled feature or feature group of a set of machine learning-enabled features or feature groups, wherein the applicability information indicates an applicability of one or more machine learning functionalities or one or more machine learning models for each machine learning-enabled feature or feature group;
transmit, to the source network entity, a report indicating the applicability information based at least in part on the reporting configuration;
receive, from the source network entity, a first control message indicating a machine learning model configuration based at least in part on the applicability information and a request to handover the UE from the source network entity to a target network entity, wherein the machine learning model configuration is associated with the one or more machine learning functionalities or the one or more machine learning models; and
receive, from the target network entity, a second control message activating the one or more machine learning functionalities or the one or more machine learning models, wherein the activation is based at least in part on the handover, the applicability information, and the machine learning model configuration.

2. The UE of claim 1, wherein, to transmit the report, the one or more processors are individually or collectively operable to execute the code to cause the UE to:
transmit, to the source network entity, a measurement report indicating the applicability information and one or more radio resource management measurements.

3. The UE of claim 1, wherein, to transmit the report, the one or more processors are individually or collectively operable to execute the code to cause the UE to:
transmit, to the source network entity, UE assistance information indicating the applicability information based at least in part on a periodicity or a trigger.

4. The UE of claim 1, wherein, to receive the message indicating the reporting configuration, the one or more processors are individually or collectively operable to execute the code to cause the UE to:
receive, from the source network entity, dedicated signaling or system information indicating the reporting configuration for reporting the applicability information.

5. The UE of claim 1, wherein the reporting configuration indicates one or more target network entity identifiers, a target coverage area, a coverage area configuration, or a combination thereof, associated with the applicability information.

6. The UE of claim 1, wherein the applicability information indicates the applicability of the one or more machine learning functionalities or the one or more machine learning models to a set of target network entities, one or more coverage areas, or a combination thereof.

7. The UE of claim 6, wherein the applicability information indicates one or more conditions for which the one or more machine learning functionalities or the one or more machine learning models are activated in a coverage area of the one or more coverage areas.

8. The UE of claim 1, wherein the target network entity is associated with a central unit or a distributed unit.

9. A source network entity, comprising:
one or more memories storing processor-executable code; and
one or more processors coupled with the one or more memories and individually or collectively operable to execute the code to cause the source network entity to:
output a message that indicates a reporting configuration for reporting applicability information for each machine learning-enabled feature or feature group of a set of machine learning-enabled features or feature groups, wherein the applicability information indicates an applicability of one or more machine learning functionalities or one or more machine learning models for each machine learning-enabled feature or feature group;
obtain a report indicating the applicability information based at least in part on the reporting configuration;
output, to a target network entity, a handover request message indicate the applicability information and a request to handover a user equipment (UE) from the source network entity to the target network entity;
obtain, from the target network entity, a handover response message indicating a machine learning model configuration based at least in part on the applicability information and the request, wherein the machine learning model configuration is associated with the one or more machine learning functionalities or the one or more machine learning models; and
output a control message indicating the machine learning model configuration.

10. The source network entity of claim 9, wherein, to obtain the report, the one or more processors are individually or collectively operable to execute the code to cause the source network entity to:
obtain a measurement report indicating the applicability information and one or more radio resource management measurements.

11. The source network entity of claim 10, wherein the handover request message indicates the one or more radio resource management measurements.

12. The source network entity of claim 9, wherein, to obtain the report, the one or more processors are individually or collectively operable to execute the code to cause the source network entity to:
obtain UE assistance information indicating the applicability information based at least in part on a periodicity or a trigger.

13. The source network entity of claim 9, wherein, to output the message indicating the reporting configuration, the one or more processors are individually or collectively operable to execute the code to cause the source network entity to:
output dedicated signaling or system information indicating the reporting configuration for reporting the applicability information.

14. The source network entity of claim 9, wherein the reporting configuration indicates one or more target network entity identifiers, a target coverage area, a coverage area configuration, or a combination thereof associated with the applicability information.

15. The source network entity of claim 9, wherein the applicability information indicates the applicability of the one or more machine learning functionalities or the one or more machine learning models to a set of target network entities, one or more coverage areas, or a combination thereof.

16. The source network entity of claim 9, wherein the target network entity is associated with a central unit or a distributed unit.

17. A user equipment (UE), comprising:
one or more memories storing processor-executable code; and
one or more processors coupled with the one or more memories and individually or collectively operable to execute the code to cause the UE to:
receive, from a source network entity, a first control message indicating, for each target network entity of a set of target network entities, a reference configuration and one or more additional configurations, wherein the one or more additional configurations correspond to one or more respective machine learning functionalities or one or more respective machine learning models; and
apply the reference configuration or the one or more additional configurations, or any combination thereof, based at least in part on a handover of the UE from the source network entity to a target network entity.

18. The UE of claim 17, wherein:
applying the reference configuration or the one or more additional configurations, or both, is based at least in part on the one or more respective machine learning functionalities or the one or more respective machine learning models satisfying an applicability condition associated with the one or more respective machine learning functionalities or the one or more respective machine learning models, wherein the applicability condition corresponds to an applicability of the reference configuration or the one or more additional configurations, or any combination thereof.

19. The UE of claim 17, wherein, to apply the reference configuration or the one or more additional configurations, or both, the one or more processors are individually or collectively operable to execute the code to cause the UE to:
apply the one or more additional configurations based at least in part on a completion of the handover and the one or more additional configurations satisfying an applicability condition associated with the one or more respective machine learning functionalities or the one or more respective machine learning models; and
transmit, to the source network entity, UE assistance information indicating the applied one or more additional configurations.

20. The UE of claim 19, wherein the one or more processors are individually or collectively further operable to execute the code to cause the UE to:
receive, from the target network entity, a control message activating the one or more respective machine learning functionalities or the one or more respective machine learning models based at least in part on the handover and the applied one or more additional configurations.

21. The UE of claim 19, wherein the UE assistance information indicates an identifier corresponding to each of the applied one or more additional configurations.

22. The UE of claim 17, wherein the one or more processors are individually or collectively further operable to execute the code to cause the UE to:
store the one or more additional configurations at the UE based at least in part on refraining to apply the one or more additional configurations.

23. The UE of claim 17, wherein the one or more processors are individually or collectively further operable to execute the code to cause the UE to:
transmit, to the source network entity, a measurement report indicating one or more radio resource management measurements.

24. The UE of claim 17, wherein the target network entity is associated with a central unit or a distributed unit.

25. A source network entity, comprising:
one or more memories storing processor-executable code; and
one or more processors coupled with the one or more memories and individually or collectively operable to execute the code to cause the source network entity to:
outputting, to a target network entity of a set of target network entities, a handover request message indicate a request to handover a user equipment (UE) from the source network entity to the target network entity;
obtain, from the target network entity, a handover response message indicating a reference configuration and one or more additional configurations, wherein the one or more additional configurations correspond to one or more respective machine learning functionalities or one or more respective machine learning models; and
output a first control message indicating, for each target network entity of the set of target network entities, the reference configuration and the one or more additional configurations.

26. The source network entity of claim 25, wherein the one or more processors are individually or collectively further operable to execute the code to cause the source network entity to:
obtain UE assistance information indicating that the one or more additional configurations are applied based at least in part on a completion of the handover and the one or more additional configurations satisfying an applicability condition associated with the one or more respective machine learning functionalities or the one or more respective machine learning models, wherein the applicability condition corresponds to an applicability of the reference configuration or the one or more additional configurations, or any combination thereof.

27. The source network entity of claim 26, wherein the one or more processors are individually or collectively further operable to execute the code to cause the source network entity to:
outputting, to the target network entity, an indication that the one or more additional configurations be applied.

28. The source network entity of claim 26, wherein the UE assistance information indicates an identifier corresponding to each of the one or more additional configurations that are applied by the UE.

29. The source network entity of claim 26, wherein the target network entity is associated with a central unit or a distributed unit.

30. A method for wireless communications at a user equipment (UE), comprising:
receiving, from a source network entity, a message indicating a reporting configuration for reporting applicability information for each machine learning-enabled feature or feature group of a set of machine learning-enabled features or feature groups, wherein the applicability information indicates an applicability of one or more machine learning functionalities or one or more machine learning models for each machine learning-enabled feature or feature group;
transmitting, to the source network entity, a report indicating the applicability information based at least in part on the reporting configuration;
receiving, from the source network entity, a first control message indicating a machine learning model configuration based at least in part on the applicability information and a request to handover the UE from the source network entity to a target network entity, wherein the machine learning model configuration is associated with the one or more machine learning functionalities or the one or more machine learning models; and
receiving, from the target network entity, a second control message activating the one or more machine learning functionalities or the one or more machine learning models, wherein the activation is based at least in part on the handover, the applicability information, and the machine learning model configuration.

31. The method of claim 30, wherein transmitting the report comprises:
transmitting, to the source network entity, a measurement report indicating the applicability information and one or more radio resource management measurements.

32. The method of claim 30, wherein transmitting the report comprises:
transmitting, to the source network entity, UE assistance information indicating the applicability information based at least in part on a periodicity or a trigger.

33. The method of claim 30, wherein receiving the message indicating the reporting configuration comprises:
receiving, from the source network entity, dedicated signaling or system information indicating the reporting configuration for reporting the applicability information.

34. A method for wireless communications at a source network entity, comprising:
outputting a message that indicates a reporting configuration for reporting applicability information for each machine learning-enabled feature or feature group of a set of machine learning-enabled features or feature groups, wherein the applicability information indicates an applicability of one or more machine learning functionalities or one or more machine learning models for each machine learning-enabled feature or feature group;
obtaining a report indicating the applicability information based at least in part on the reporting configuration;
outputting, to a target network entity, a handover request message indicating the applicability information and a request to handover a user equipment (UE) from the source network entity to the target network entity;
obtaining, from the target network entity, a handover response message indicating a machine learning model configuration based at least in part on the applicability information and the request, wherein the machine learning model configuration is associated with the one or more machine learning functionalities or the one or more machine learning models; and
outputting a control message indicating the machine learning model configuration.

35. The method of claim 34, wherein obtaining the report comprises:
obtaining a measurement report indicating the applicability information and one or more radio resource management measurements.

36. The method of claim 34, wherein obtaining the report comprises:
obtaining UE assistance information indicating the applicability information based at least in part on a periodicity or a trigger.

37. A method for wireless communications at a user equipment (UE), comprising:
receiving, from a source network entity, a first control message indicating, for each target network entity of a set of target network entities, a reference configuration and one or more additional configurations, wherein the one or more additional configurations correspond to one or more respective machine learning functionalities or one or more respective machine learning models; and
applying the reference configuration or the one or more additional configurations, or any combination thereof, based at least in part on a handover of the UE from the source network entity to a target network entity.

38. The method of claim 37, wherein:
applying the reference configuration or the one or more additional configurations, or both, is based at least in part on the one or more respective machine learning functionalities or the one or more respective machine learning models satisfying an applicability condition associated with the one or more respective machine learning functionalities or the one or more respective machine learning models, and
the applicability condition corresponds to an applicability of the reference configuration or the one or more additional configurations, or any combination thereof.

39. The method of claim 37, wherein applying the reference configuration or the one or more additional configurations, or both comprises:
applying the one or more additional configurations based at least in part on a completion of the handover and the one or more additional configurations satisfying an applicability condition associated with the one or more respective machine learning functionalities or the one or more respective machine learning models; and
transmitting, to the source network entity, UE assistance information indicating the applied one or more additional configurations.

40. The method of claim 39, further comprising:
receiving, from the target network entity, a control message activating the one or more respective machine learning functionalities or the one or more respective machine learning models based at least in part on the handover and the applied one or more additional configurations.

41. A method for wireless communications at a source network entity, comprising:
outputting, to a target network entity of a set of target network entities, a handover request message indicating a request to handover a user equipment (UE) from the source network entity to the target network entity;
obtaining, from the target network entity, a handover response message indicating a reference configuration and one or more additional configurations, wherein the one or more additional configurations correspond to one or more respective machine learning functionalities or one or more respective machine learning models; and
outputting a first control message indicating, for each target network entity of the set of target network entities, the reference configuration and the one or more additional configurations.

42. The method of claim 41, further comprising:
obtaining UE assistance information indicating that the one or more additional configurations are applied based at least in part on a completion of the handover and the one or more additional configurations satisfying an applicability condition associated with the one or more respective machine learning functionalities or the one or more respective machine learning models, wherein the applicability condition corresponds to an applicability of the reference configuration or the one or more additional configurations, or any combination thereof.

43. The method of claim 42, further comprising:
outputting, to the target network entity, an indication that the one or more additional configurations are applied.
